(19) United States
(12) Patent Application Publication
(10) Pub. No.: US 2024/0397432 A1
(43) Pub. Date: Nov. 28, 2024

(54) INTER-UE INTERFERENCE MITIGATION BASED ON UPLINK POWER CONTROL

(71) Applicant: QUALCOMM Incorporated, San Diego, CA (US)

(72) Inventors: Marwen ZORGUI, San Diego, CA (US); Ahmed Attia ABOTABL, San Diego, CA (US); Muhammad Sayed Khairy ABDELGHAFFAR, San Jose, CA (US)

(21) Appl. No.: 18/324,809

(22) Filed: May 26, 2023

(51) Int. Cl. H04W 52/14; H04W 52/36

(52) U.S. Cl. CPC H04W 52/146; H04W 52/367

(57) ABSTRACT

This disclosure provides methods, components, devices and systems for uplink power control in which an aggressor UE applies different power control schemes in respective uplink resource allocations to mitigate inter-UE interference or simplify NLIC at the victim UE. The aggressor UE initially obtains a first uplink resource allocation in which one power control scheme is to be applied, and determines at least a second uplink resource allocation including a subset of resources of the first uplink resource allocation in which a different power control scheme is to be applied. The UE also obtains various uplink power control parameters associated with the respective uplink resource allocations, where one or more of these parameters has a different value for the second uplink resource allocation than for first uplink resource allocation. The UE then sends uplink data in the uplink resource allocations using different transmission powers associated with the different parameters.

### TECHNICAL FIELD

The present disclosure generally relates to wireless communication including uplink power control, and more particularly, to a wireless communication system applying different transmission power schemes in respective uplink resource allocations to mitigate inter-UE interference.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure can be implemented in a method for wireless communication performable at a first user equipment (UE). The method includes obtaining a first uplink power control parameter associated with a first uplink resource allocation, obtaining a second uplink power control parameter associated with a second uplink resource allocation, sending a first uplink transmission in the first uplink resource allocation using a first transmission power associated with the first uplink power control parameter, and sending a second uplink transmission in the second uplink resource allocation using a second transmission power associated with the second uplink power control parameter. The second uplink resource allocation overlaps in time and frequency with a portion of the first uplink resource allocation. The second uplink resource allocation further overlaps in time with a downlink resource allocation for a second UE. The second transmission power is less than the first transmission power in response to the second uplink power control parameter having a different value than the first uplink power control parameter.

Another innovative aspect of the subject matter described in this disclosure can be implemented in an apparatus for wireless communication, such as a first UE. The apparatus includes one or more memories, and one or more processors each communicatively coupled with at least one of the one or more memories. The one or more processors, individually or in any combination, are operable to cause the apparatus to obtain a first uplink power control parameter associated with a first uplink resource allocation, obtain a second uplink power control parameter associated with a second uplink resource allocation, send a first uplink transmission in the first uplink resource allocation using a first transmission power associated with the first uplink power control parameter, and send a second uplink transmission in the second uplink resource allocation using a second transmission power associated with the second uplink power control parameter. The second uplink resource allocation overlaps in time and frequency with a portion of the first uplink resource allocation. The second uplink resource allocation further overlaps in time with a downlink resource allocation for a second UE. The second transmission power is less than the first transmission power in response to the second uplink power control parameter having a different value than the first uplink power control parameter.

Another innovative aspect of the subject matter described in this disclosure can be implemented in an apparatus for wireless communication, such as a first UE. The apparatus includes means for obtaining a first uplink power control parameter associated with a first uplink resource allocation and a second uplink power control parameter associated with a second uplink resource allocation, and means for sending a first uplink transmission in the first uplink resource allocation using a first transmission power associated with the first uplink power control parameter and a second uplink transmission in the second uplink resource allocation using a second transmission power associated with the second uplink power control parameter. The second uplink resource allocation overlaps in time and frequency with a portion of the first uplink resource allocation. The second uplink resource allocation further overlaps in time with a downlink resource allocation for a second UE. The second transmission power is less than the first transmission power in response to the second uplink power control parameter having a different value than the first uplink power control parameter.

Another innovative aspect of the subject matter described in this disclosure can be implemented in a non-transitory, computer-readable medium comprising computer executable code. The code when executed by one or more processors causes the one or more processors to, individually or in combination, obtain a first uplink power control parameter associated with a first uplink resource allocation, obtain a second uplink power control parameter associated with a second uplink resource allocation, send a first uplink transmission in the first uplink resource allocation using a first transmission power associated with the first uplink power control parameter, and send a second uplink transmission in the second uplink resource allocation using a second transmission power associated with the second uplink power control parameter. The second uplink resource allocation overlaps in time and frequency with a portion of the first uplink resource allocation. The second uplink resource allocation further overlaps in time with a downlink resource allocation for a second UE. The second transmission power is less than the first transmission power in response to the second uplink power control parameter having a different value than the first uplink power control parameter.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram of a base station (BS) in communication with a UE in an access network.

FIG. 4 is a diagram illustrating an example of a base station in wireless communication with a first UE and with a second UE that is in geographic proximity to first UE.

FIG. 5 is a diagram illustrating an example of a non-linear interference cancellation (NLIC) system.

FIG. 6 is a diagram illustrating an example of a chart showing a spectrum of downlink and uplink signals with varying amplitudes or transmission powers including nonlinear effects applied to the downlink signals.

FIG. 7 is a diagram illustrating an example of a first uplink resource allocation and a second uplink resource allocation including resources in which a UE may transmit uplink data to a base station using different power control schemes.

FIG. 8 is a diagram illustrating an example of a call flow between a UE and a base station.

FIG. 9 is a flowchart of a method for wireless communication performable at a UE.

FIG. 10 is a diagram illustrating an example of a hardware implementation for a UE apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects generally relate to uplink power control in wireless communication systems. More particularly, aspects specifically relate to a wireless communication system in which an aggressor UE, or a UE that causes inter-UE interference at a victim UE, applies different transmission power schemes in respective uplink resource allocations. The application of different transmission power schemes allows for mitigation of inter-UE interference impacting the victim UE or simplification of nonlinear interference cancellation (NLIC) at the victim UE. In various aspects, an aggressor UE may apply different power control schemes to its uplink transmissions depending on the resources in which its uplink data is to be sent. For instance, the aggressor UE may apply a power control scheme resulting in lesser transmission power to uplink resources that overlap in time and are relatively close in frequency to allocated downlink resources of the victim UE, since these resources are more likely to result in inter-UE interference impacting the victim UE, yet apply a different power control scheme resulting in greater transmission power to the other uplink resources.

In one example, the aggressor UE may obtain a configuration or grant indicating a first uplink resource allocation in which one power control scheme is to be applied, and the aggressor UE may determine at least a second uplink resource allocation including a subset of resources of the first uplink resource allocation in which a different power control scheme is to be applied. After determining at least the first and second uplink resource allocations, the aggressor UE may obtain various uplink power control parameters associated with the respective uplink resource allocations, where one or more of these parameters may have a different value for the second uplink resource allocation than for first uplink resource allocation. For instance, the UE may obtain one nominal or initial power component associated with the first uplink resource allocation and a different nominal or initial power component associated with the second uplink resource allocation, one RB quantity associated with the first uplink resource allocation and a different RB quantity associated with the second uplink resource allocation, one power control adjustment state associated with the first uplink resource allocation and a different power control adjustment state associated with the second uplink resource allocation, obtain one configured maximum output power associated with the first uplink resource allocation and a different configured maximum output power associated with the second uplink resource allocation, or the like. After obtaining the uplink power control parameters, the UE may send uplink data in the uplink resource allocations using different transmission powers associated with the different uplink power control parameters. Thus, through application of different power control schemes to different uplink resource allocations, the aggressor UE may increase or maximize transmission power to improve uplink coverage in some resources, while reducing transmission power to minimize or reduce inter-UE interference with a victim UE in other resources. As a result, an aggressor UE may be able to successfully transmit data to the base station without impacting or increasing NLIC complexity at a victim UE.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

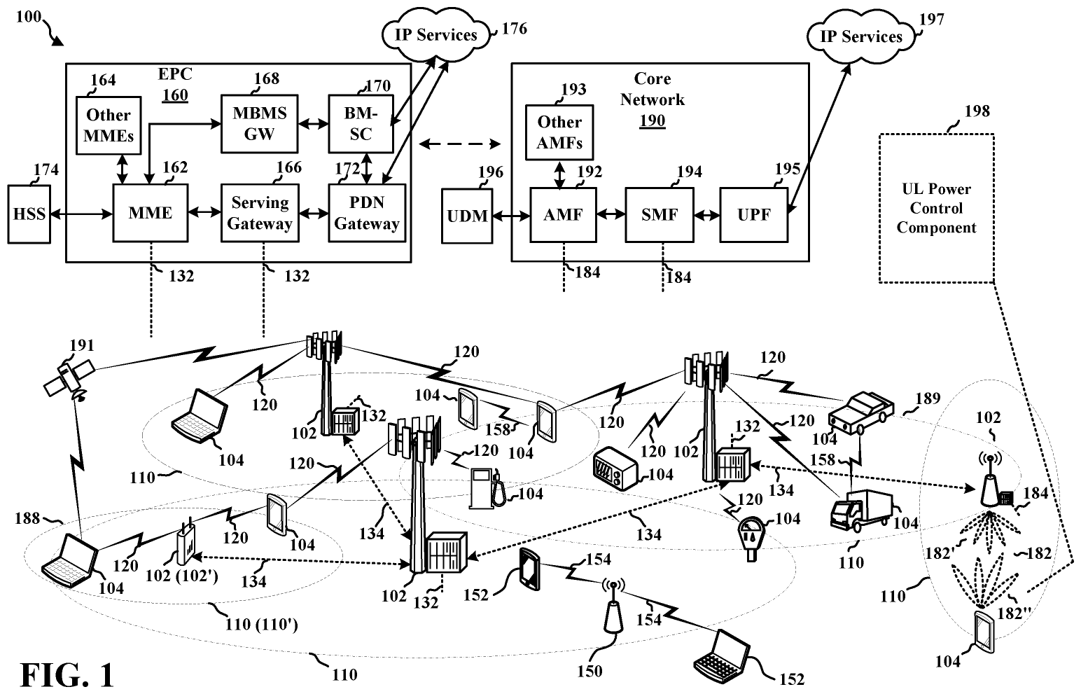

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as base station 102 may operate in a traditional sub 6 GHz spectrum, in millimeter wave frequencies, and/or near millimeter wave frequencies in communication with the UE 104. When the gNB operates in millimeter wave or near millimeter wave frequencies, the gNB may be referred to as a millimeter wave base station. The millimeter wave base station may utilize beamforming 182 with the UE 104 to compensate for the path loss and short range. The base station 102 and the UE 104 may each include a plurality of antennas, such as antenna elements, antenna panels, and/or antenna arrays to facilitate the beamforming.

The base station 102 may transmit a beamformed signal to the UE 104 in one or more transmit directions 182′. The UE 104 may receive the beamformed signal from the base station 102 in one or more receive directions 182″. The UE 104 may also transmit a beamformed signal to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The wireless communications system and access network 100 may be or include a non-terrestrial network (NTN), a terrestrial network (TN), or a combination of non-terrestrial and terrestrial networks. An NTN is a network involving non-terrestrial flying objects, and may include, but is not limited to, a satellite communication network, a high-altitude platform system (HAPS), or an air-to-ground network, among other networks. Thus, a cell in an NTN may be served by a spaceborne platform such as a low Earth orbiting (LEO) satellite, a medium Earth orbiting (MEO) satellite, or a geosynchronous Earth orbiting (GEO) satellite, an airborne platform such as an International Mobile Telecommunications base station (HIBS), a ground station having antennas up-tilted towards the sky for providing in-flight connectivity, or other base station or network entity providing NTN connectivity. In contrast, a TN is a network that does not involve satellites or other such non-terrestrial flying objects. Thus, a cell in a TN may be served by a ground station or other network entity that provides terrestrial coverage to UEs. In the example wireless communications system and access network 100 of FIG. 1, NTN cells 188, TN cells 189, or both NTN cells 188 and TN cells 189, may be provided. For example, at least one coverage area 110 or cell may be an NTN cell 188 in which base station 102 provides non-terrestrial coverage to UEs 104 via satellite 191. Alternatively or additionally, at least one other coverage area 110 or cell may be a TN cell 189 in which base station 102 provides terrestrial coverage to UEs 104 (without a satellite intermediary).

In certain aspects, the UE 104 may include a UL power control component 198 that is configured to apply different transmission power schemes in respective uplink resource allocations to mitigate inter-UE interference or simplify NLIC at another UE. For example, the UL power control component 198 may be configured to obtain a first uplink power control parameter associated with a first uplink resource allocation, obtain a second uplink power control parameter associated with a second uplink resource allocation, send a first uplink transmission in the first uplink resource allocation using a first transmission power associated with the first uplink power control parameter, and send a second uplink transmission in the second uplink resource allocation using a second transmission power associated with the second uplink power control parameter. The second uplink resource allocation may overlap in time and frequency with a portion of the first uplink resource allocation. The second uplink resource allocation may further overlap in time with a downlink resource allocation for a second UE. The second transmission power may be less than the first transmission power in response to the second uplink power control parameter having a different value than the first uplink power control parameter.

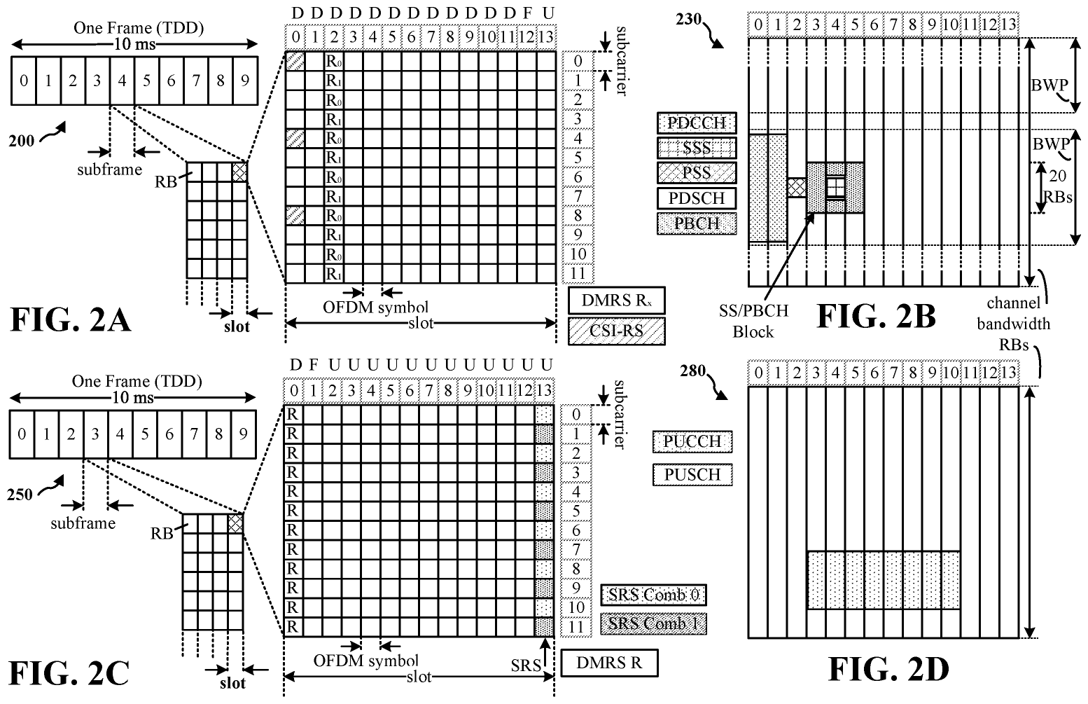

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through downlink control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

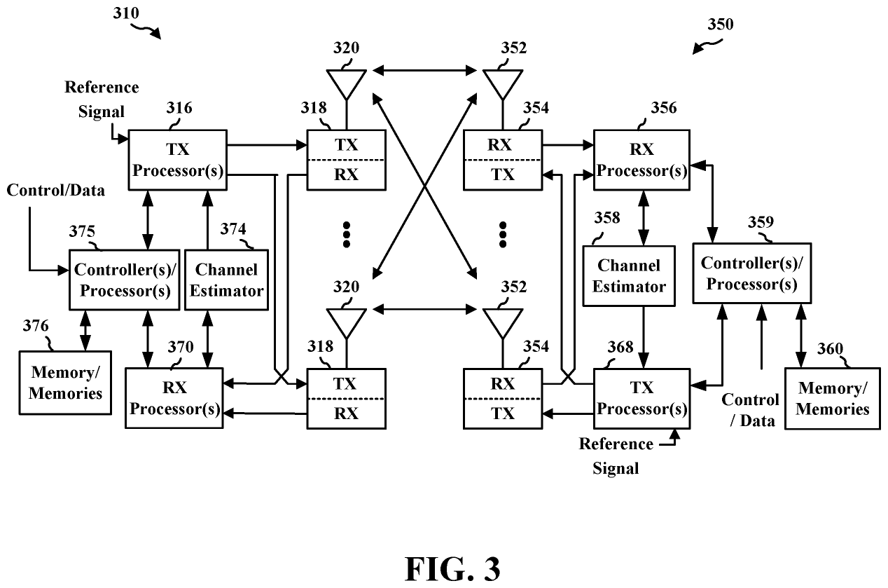

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 can each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 can each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with UL power control component 198 of FIG. 1.

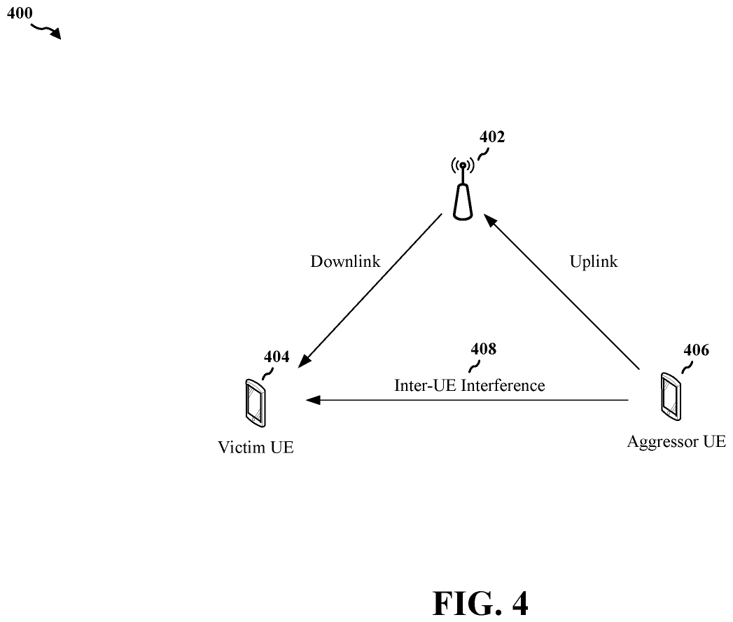

FIG. 4 illustrates an example 400 of a base station 402 in wireless communication with a first UE 404 and with a second UE 406 that is in geographic proximity to first UE 404. In cases where first UE 404 is a full duplex node, or a UE that may simultaneously receive downlink data and transmit uplink data in a same frequency band, first UE 404 may experience self-interference. For example, if first UE 404 transmits uplink data at a same time that first UE 404 receive downlink data, the uplink transmission may interfere with the first UE's ability to decode the downlink transmission. Additionally or alternatively, in certain cases, first UE 404 may experience inter-UE interference 408 from second UE 406. For example, if base station 402 is scheduled or configured to transmit downlink data to first UE 404 at a same time that second UE 406 is scheduled or configured to transmit uplink data to base station 402, the uplink transmission of second UE 406 may interfere with the ability of first UE 404 to receive the downlink transmission from base station 402. In such scenarios, second UE 406 may be referred to as an aggressor UE, and first UE 404 may be referred to as a victim UE, since first UE 404 is a victim of interference by second UE 406.

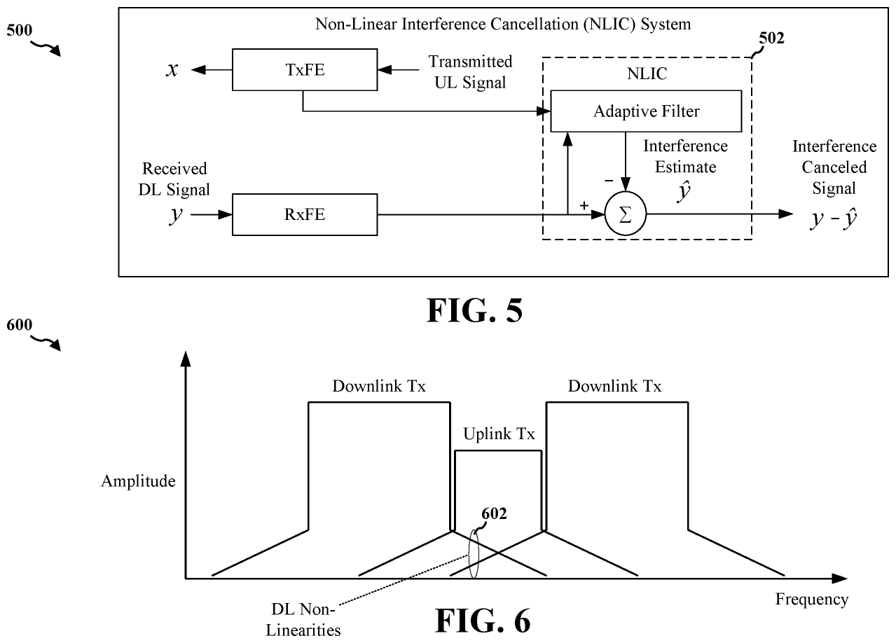

Self-interference and inter-UE interference 408 may be subject to non-linearities resulting from power amplifiers or other sources of non-linear effects applied to a signal. For example, these sources may be at a transmitter, receiver, or transceiver of the first UE 404 or second UE 406, in the channel between the first UE 404 and the base station 402, or in the channel between the second UE 406 and the base station 402. Generally, to remove the self-interference or inter-UE interference 408 caused by the uplink transmission, first UE 404 may apply non-linear interference cancellation (NLIC) to the received downlink transmission. For instance, FIG. 5 illustrates an example 500 of an NLIC system where a UE, such as first UE 404, may apply NLIC 502 to cancel self-interference or inter-UE interference 408 from a received downlink signal y (n) at first UE 404. Here, downlink signal y (n) includes non-linear effects resulting from a transmitted uplink signal x (n) from first UE 404 in self-interference or second UE 406 in inter-UE interference. In the example of FIG. 5, the downlink signal y (n) may be received over a channel via a reception front end (RxFE) or Rx chain or receiver at first UE 404, while the uplink signal x (n) may be transmitted over the same channel or a different channel via a transmission front end (TxFE) or Tx chain or transmitter at either first UE 404 in self-interference or second UE 406 in inter-UE interference.

In one example, during NLIC 502, the first UE 404 may initially estimate a non-linear model, such as a memory polynomial model, from a clean baseband signal such as uplink transmission signal x (n). An example of a memory polynomial model is: ŷ(n)=Σ_{k=3,k=odd}^{k}Σₘ₌₀^{M-1}a_{k,m}xₖ (n−m), where Kernel xₖ (n)=x(n)|x(n)|^{k-1}, M is a memory length, K is a maximum Kernel order, and a_{k,m} are model weights obtained from training data using an adaptive filter such as least squares estimation. Thus, using this adaptive filter as well as the clean baseband, uplink transmission signal x (n), the first UE 404 may estimate the uplink signal ŷ (n) including the interference and non-linearities. After obtaining the estimated interference ŷ(n), the first UE 404 may subtract this estimate from the received downlink signal y(n), thereby cancelling the interference resulting from the simultaneously transmitted UL signal of the first UE 404 or the second UE 406.

However, while NLIC 502 may be effective in cancelling self-interference or inter-UE interference 408 applied to a received signal at first UE 404, NLIC 502 may be more challenging to apply for inter-UE interference scenarios than for self-interference scenarios. This challenge exists because the first UE 404 may not be able to easily ascertain non-linearities associated with power amplifiers, transceivers, or other components of a different device such as the second UE 406 in contrast to the non-linearities associated with similar components at the same device or first UE 404. For instance, FIG. 6 illustrates an example 600 of a chart showing a spectrum of downlink and uplink signals with varying amplitudes or transmission powers including non-linear effects applied to the downlink signals. If such non-linear effects originate from non-linear components of an aggressor UE, as may be the case in inter-UE interference scenarios, the victim UE may be more challenged in attempting to accurately model and cancel these non-linearities from the received downlink signal using the NLIC system of FIG. 5 than in self-interference scenarios. For instance, non-linearities 602 in FIG. 6 may be more difficult to model in a NLIC system where the TxFE in FIG. 5 is part of second UE 406 rather than first UE 404.

Therefore, it would be helpful to provide a system in which inter-UE interference 408 may be reduced, eliminated, or otherwise controlled so that first UE 404 may successfully decode its downlink transmission from the base station 402 with minimal or no additional NLIC complexity while also providing minimal impact to uplink performance at second UE 406. To this end, aspects of the present disclosure provide for the aggressor UE or second UE 406 to apply different power control schemes to its uplink transmissions depending on the resources in which the uplink data is to be sent. For example, the second UE 406 may transmit uplink data using one power control scheme resulting in lesser transmission power in uplink resources that are more likely to result in inter-UE interference 408 with the first UE 404, while transmitting uplink data using another power control scheme resulting in greater transmission power in uplink resources that are less likely to result in inter-UE interference 408 with the first UE 404. Resources that are more likely to result in inter-UE interference 408 include allocated uplink resources of the second UE 406 that overlap in time and are relatively close in frequency to allocated downlink resources of the first UE 404. Thus, through application of different power control schemes in different uplink resources, an aggressor UE may be able to achieve sufficient uplink coverage without impacting or increasing NLIC complexity at a victim UE. For example, the second UE 406 may increase transmission power to improve uplink performance in less or non-interfering resources with the first UE 404, while reducing transmission power to decrease inter-UE interference in potentially or more interfering resources with the first UE 404.

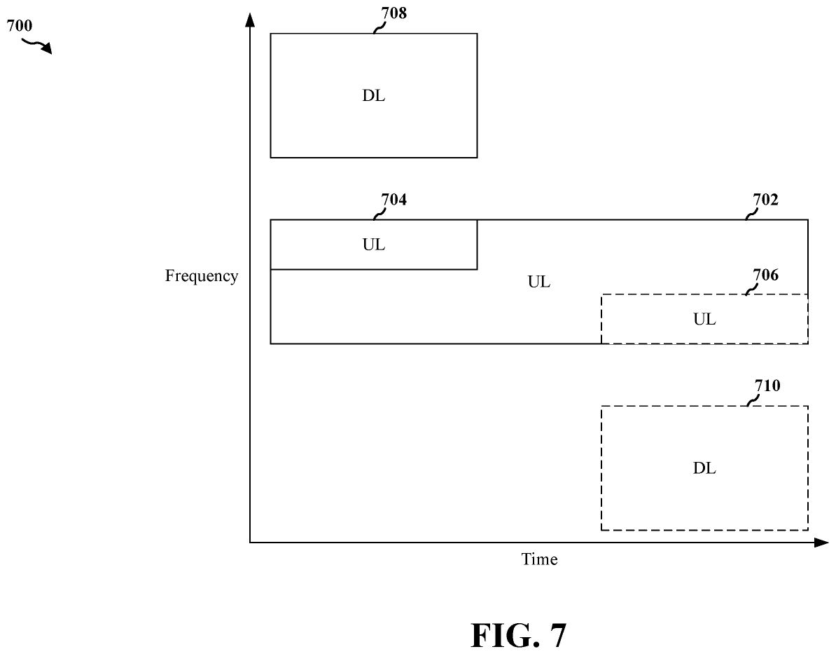

FIG. 7 illustrates an example 700 of a first uplink resource allocation 702 and a second uplink resource allocation 704 including resources in which second UE 406 transmits uplink data to base station 402 using different power control schemes. For example, second UE 406 may transmit uplink data in second uplink resource allocation 704 with a power control scheme resulting in lesser transmission power than that applied to first uplink resource allocation 702. In other examples, the second UE 406 may transmit uplink data in additional uplink resources, such as in third uplink resource allocation 706, using a same or different power control scheme as applied to second uplink resource allocation 704. The power control schemes applied to second uplink resource allocation 704 and third uplink resource allocation 706 may be configured to result in lesser transmission power than that associated with first uplink resource allocation 702 since the resources in the uplink resource allocations 704, 706 may be more prone to causing inter-UE interference affecting first UE 404 than the remaining resources in first uplink resource allocation 702.

More particularly, with reference to the example 700 of FIG. 7, first uplink resource allocation 702 includes resources which base station 402 configures or schedules to second UE 406 for sending uplink data such as PUSCH data or PUCCH data. For instance, first uplink resource allocation 702 may be indicated in an uplink grant, a configured grant configuration, or the like. Second uplink resource allocation 704, on the other hand, is a base station configured or UE determined subset of first uplink resource allocation 702 which is prone to inter-UE interference 408. For example, second uplink resource allocation 704 includes resources which overlap in time with a downlink resource allocation 708 to first UE 404, and which frequencies are associated with non-linear signal effects such as non-linearities 602 that are challenging for first UE 404 to cancel using NLIC 502 due to these uplink resources' relative proximity to downlink resource allocation 708. In some examples, the base station 402 may also configure, or the second UE 406 may also determine, additional uplink resources which are prone to inter-UE interference 408, such as third uplink resource allocation 706. For example, third uplink resource allocation 706 may include resources which similarly overlap in time with a downlink resource allocation 710 to first UE 404, and which frequencies are likewise associated with non-linear signal effects such as non-linearities 602 that are challenging for first UE 404 to cancel using NLIC 502 due to these uplink resources' relative proximity to downlink resource allocation 710. Here, downlink resource allocation(s) 708, 710 may be dynamic or semi-static resources such as periodic or semi-persistently scheduled resources of the first UE 404 or another UE. Moreover, second UE 406 may determine the times and frequencies of these downlink resources via a downlink indication from base station 402 to second UE 406 in a DCI, MAC-CE, or RRC configuration, or via a sidelink indication such as during inter-UE coordination (IUC) from first UE 404 or a different UE.

Accordingly, since the resources in second uplink resource allocation 704 and third uplink resource allocation 706 are more likely to result in inter-UE interference 408 with downlink resource allocations 708, 710 than the remaining resources in first uplink resource allocation 702, the second UE 406 may apply different uplink power control schemes to these respective uplink resource allocations to address this inter-UE interference 408 with no or minimal impact to NLIC complexity at the first UE 404. For instance, for PUSCH transmissions or PUCCH transmissions configured or scheduled in the resources of first uplink resource allocation 702 which also fall within the second uplink resource allocation 704 or the third uplink resource allocation 706, the second UE 406 may apply one power control scheme resulting in a lesser transmission power in these resources. This behavior may serve to reduce or avoid the effect of non-linearities associated with the second UE 406 interfering with a downlink received signal at the first UE 404 or a different UE. In contrast, for PUSCH transmissions or PUCCH transmissions configured or scheduled in the remaining resources of first uplink resource allocation 702 which do not fall within the other resource allocations 704, 706, the second UE 406 may apply another power control scheme resulting in a greater transmission power in these resources. This behavior may allow the second UE 406 to maximize the likelihood of its uplink transmissions being successfully received at the base station 402 without having to sacrifice performance in these resources due to inter-UE interference considerations. Thus, improved performance may be experienced at an aggressor UE without compromising performance at a victim UE.

While the various examples and aspects mentioned throughout the disclosure refer to first UE 404 or victim UE as being a full duplex node and thus subject to self-interference and inter-UE interference 408, these examples and aspects may similarly refer to the case where first UE 404 is a half-duplex node, since such nodes may similarly experience inter-UE interference 408 from the second UE 406 or an aggressor UE. Thus, the various aspects of this disclosure may not only minimize inter-UE interference or NLIC complexity in full duplex UEs that simultaneously receive downlink data and transmit uplink data, but also in half duplex UEs that do not simultaneously receive downlink data and transmit uplink data. Moreover, these aspects may be of particular benefit to half duplex victim UEs which communicate in frequency division multiplexed (FDM) resources having a relatively short separation between uplink and downlink resource allocations or frequency bands, since such resources may be more prone to inter-UE interference than FDM resources having a relatively large separation between uplink and downlink resource allocations or frequency bands.

Generally, when a UE applies an uplink power control scheme for its PUSCH or PUCCH transmissions without regard to inter-UE interference 408, the UE may follow a specific formula with various uplink power control parameters. For instance, Equation (1) below illustrates an example of an uplink power control formula for PUSCH which second UE 406 may generally apply to PUSCH transmissions configured or scheduled in first uplink resource allocation 702:

$${P}_{PUSCH , b , f , c} ( I , j , {q}_{d} , l ) = min \{ \begin{matrix}{P}_{CMAX , f , c} ( I ) , \\ {P}_{{O}_{PUSCH} , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( I , l )\end{matrix} \} [ dBM ] \qquad ( 1 )$$

where P_{PUSCH, b,f,c}(I, j, q_{d}, 1) is a PUSCH transmission power in a PUSCH transmission occasion i on an active UL BWP b of carrier f of serving cell c using a parameter set configuration with index j and a PUSCH power control adjustment state with index 1, P_{CMAX,f,c} (1) is a UE configured maximum output power for carrier f of serving cell c in PUSCH transmission occasion I, P_{O_PUSCH,b,f,c}(j) is a parameter composed of the sum of a nominal power component P_{O_NOMINAL,PUSCH,f,c} (j) and an initial power component P_{O_UE_PUSCH,b,f,c}(j), M_{RB,b,f,c}^{PUSCH} (1) is a bandwidth of the PUSCH resource assignment (the first uplink resource allocation 702 in one example) expressed in number of resource blocks for PUSCH transmission occasion i on active UL BWP b of carrier f of serving cell c and μ is a subcarrier spacing (SCS) configuration, α_{b,f,c} (j) is a parameter associated with random access channels (RACH) or SRS, PL_{b,f,c} (q_{d}) is a downlink pathloss estimate in dB calculated by the UE using reference signal (RS) index q_{d} for the active DL BWP of carrier f of serving cell c, Δ_{TF,b,f,c} (I) is a parameter associated with MCS, and f_{p,f,c} (I, 1) is a PUSCH power control adjustment state for active UL BWP b of carrier f of serving cell c in PUSCH transmission occasion i which state may be a function of a transmission power control (TPC) command value or accumulation parameter in DCI and which state may be associated with different transmission beams of antenna panels.

Similarly, Equation (2) below illustrates an example of an uplink power control formula for PUCCH which second UE 406 may generally apply to PUCCH transmissions configured or scheduled in first uplink resource allocation 702:

$${P}_{PUCCH , b , f , c} ( i , {q}_{u} , {q}_{d} , l ) = min \{ \begin{matrix}{P}_{CMAX , f , c} ( i ) , \\ {P}_{{O}_{PUCCH} , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + {Δ}_{{F}_{PUCCH}} ( F ) + {Δ}_{TF , b , f , c} ( i ) + {g}_{b , f , c} ( i , l )\end{matrix} \} [ dBM ] \qquad ( 2 )$$

where P_{PUCCH,b,f,c} (I, qᵤ, q_{d}, 1) is a PUCCH transmission power in a PUCCH transmission occasion i on an active UL BWP b of carrier f of primary cell c using a PUCCH power control adjustment state with index 1, P_{CMAX,f,c} (I) is a UE configured maximum output power for carrier f of primary cell c in PUCCH transmission occasion I, P_{O_PUCCH,b,f,c} (qᵤ) is a parameter composed of the sum of a nominal power component P_{O_NOMINAL,PUCCH} and an initial power component P_{O_UE_PUCCH} (qᵤ), M_{RB,b,f,c}^{PUCCH} (I) is a bandwidth of the PUCCH resource assignment (the first uplink resource allocation 702 in another example) expressed in number of resource blocks for PUCCH transmission occasion i on active UL BWP b of carrier f of primary cell c and μ is a SCS configuration, PL_{b,f,c} (q_{d}) is a downlink pathloss estimate in dB calculated by the UE using RS index q_{d} for the active DL BWP of carrier f of primary cell c, Δ_{F_PUCCH} (F) is a parameter associated with a PUCCH format, Δ_{TF,b,f,c} (I) is a PUCCH transmission power adjustment component, and g_{b,f,c} (I, 1) is a PUCCH power control adjustment state for active UL BWP b of carrier f of primary cell c in PUCCH transmission occasion i which state may be a function of a TPC command value or accumulation parameter in DCI and which state may be associated with different transmission beams of antenna panels.

However, while applying power control schemes such as according to Equations (1) or (2) to resources in first uplink resource allocation 702 may provide adequate uplink coverage to second UE 406, uniformly applying the same scheme to resources overlapping in time and relatively close in frequency to a downlink resource allocation of first UE 404, such as to resources in second uplink resource allocation 704 or third uplink resource allocation 706, may result in inter-UE interference 408 including non-linearities 602. Therefore, aspects of the present disclosure provide for the second UE 406 to apply a different power control scheme, such as one or more different power control parameters, values, or formulas than those indicated in Equations (1) or (2) for its PUSCH or PUCCH transmissions, in scenarios where one or more of downlink resource allocations 708, 710 are present, or otherwise where inter-UE interference 408 including non-linearities 602 from second UE 406 may impact downlink transmissions to first UE 404. For instance, different power control parameters, values, or functions than those illustrated in Equations (1) or (2) may be configured for second UE 406 to apply for transmissions in resources that are more likely to cause inter-UE interference 408 with a victim UE such as in second uplink resource allocation 704 or third uplink resource allocation 706, than in resources which are less likely to result in inter-UE interference such as the remaining resources of first uplink resource allocation 702. As an example, the second UE 406 may apply one value to one or more of the power control parameters of Equations (1) or (2) or some other power control scheme when sending PUSCH or PUCCH transmissions in first uplink resource allocation 702, but apply a different value to the same power control parameters of Equations (1) or (2) or some other different power control scheme when sending PUSCH or PUCCH transmissions in second uplink resource allocation 704 or third uplink resource allocation 706. By using different parameters, values, formulas, or other power controls schemes depending on the uplink resource allocation, the second UE 406 may obtain different transmission powers which may respectively be applied in the different uplink resource allocations, thereby allowing the network to balance aggressor UE transmission performance and victim UE reception or NLIC performance.

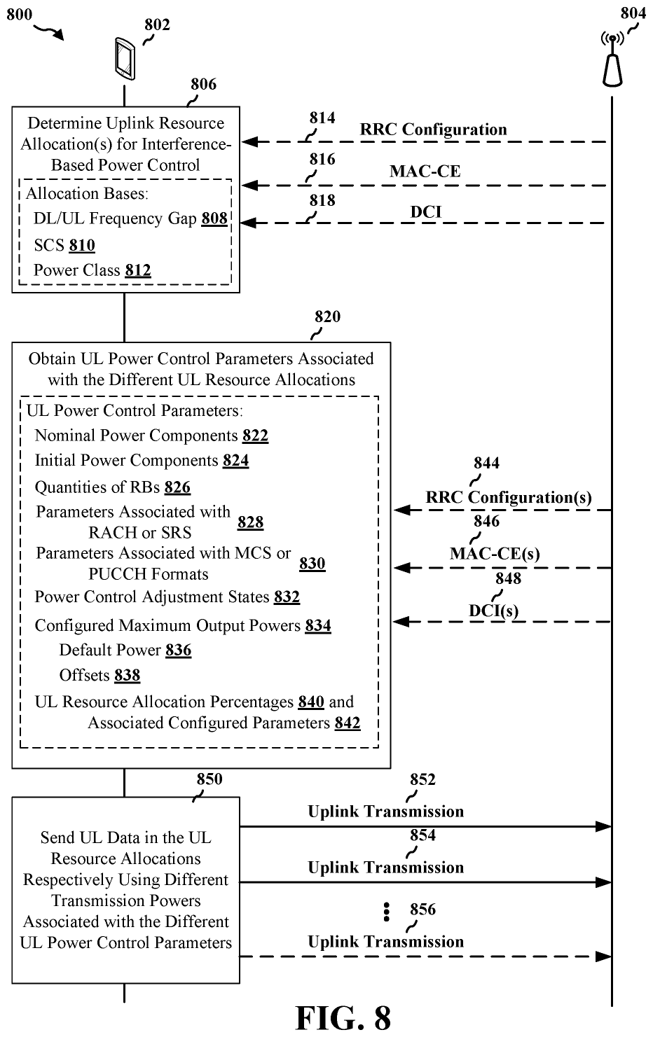

FIG. 8 illustrates an example 800 of a call flow between a UE 802 and a base station 804. UE 802 may correspond to second UE 406 and UE 104, 350. Base station 804 may correspond to base station 102, 310, 402. Initially at block 806, the UE 802 may determine uplink resource allocation(s) in which to apply different power control schemes to address inter-UE interference 408. For instance, the UE 802 may obtain a configuration or grant indicating first uplink resource allocation 702 in which one power control scheme is to be applied, and the UE may determine at block 806 the subset(s) of resources of the first uplink resource allocation 702, as well as the quantity of subset(s) of resources, in which different power control scheme(s) are respectively to be applied.

In one example at block 806, UE 802 may determine the subset(s) of resources of first uplink resource allocation 702 in which to apply different power control scheme(s) based on one or more factors or parameters of a configured or pre-configured function such as a formula or equation. These factor(s) may include but are not limited to, for example, a frequency separation 808 or number of RBs between an uplink resource and an overlapping downlink resource in the time domain to a different UE such as first UE 404, a subcarrier spacing 810 associated with the uplink resource or the time overlapping downlink resource, and a power class 812 or category of the UE 802 or the different UE. The UE 802 may apply this function, or multiple functions using these same or different factor(s), to determine the subset(s) of resources of first uplink resource allocation 702 that are likely to cause inter-UE interference 408. For instance, the UE 802 may apply these factor(s) to determine the time-frequency locations of second uplink resource allocation 704 and third uplink resource allocation 706 and the number of such uplink resource allocations. In other examples, more or less uplink resource allocation(s) overlapping in time with downlink resource allocations may be determined based on same or different factor(s). Accordingly, the UE 802 may consider the proximity of uplink resources to downlink resource allocations 708, 710 as indicated by frequency separation 808 and subcarrier spacing 810, as well as the transmission power capabilities of the aggressor UE or victim UE as indicated by power class 812, to ascertain the quantity and location of time-frequency resources in uplink resource allocation(s) 704, 706. For example, if the UE 802 determines that certain resources of first uplink resource allocation 702 have a certain amount of frequency separation at a given SCS to a time-overlapping, downlink resource allocation of another UE such as downlink resource allocation 708, 710, and that these resources are associated with a higher power aggressor UE or overlap in time with downlink resources associated with a lower power victim UE having less sophisticated NLIC capability, the UE 802 may identify these resources as being prone to inter-UE interference. As a result, the UE may designate these resources for different power control in second uplink resource allocation 704 or third uplink resource allocation 706.

In another example at block 806, UE 802 may determine the subset(s) of resources of first uplink resource allocation 702 in which to apply different power control scheme(s) based on layer 1, layer 2, or layer 3 signaling. For instance, the base station 804 may transmit an indication in an RRC configuration 814, MAC-CE 816, or DCI 818 of the subset(s) of resources of first uplink resource allocation 702 in which the UE is to apply a different power control scheme than that applied to first uplink resource allocation 702. Accordingly, the UE 802 may ascertain the quantity and location of time-frequency resources in uplink resource allocation(s) 704, 706 from the received indication. For example, one or more RRC configurations 814, MAC-CEs 816, DCIs 818, or a combination of these configurations, may indicate to UE 802 the quantities and location of the time-frequency resources for second uplink resource allocation 704 and third uplink resource allocation 706.

Thus, at block 806, the UE 802 may derive the subset(s) of resources, such as second uplink resource allocation 704 and third uplink resource allocation 706, as well as the quantity of such resource allocations, in multiple manners. For instance, the UE 802 may determine these resource allocations and quantities autonomously from one or more formulas, equations, or other functions based on various factors, or the UE 802 may explicitly receive one or more indications of these resource allocations or quantities via layer 1, layer 2, or layer 3 signaling from base station 804. While the former or deterministic approach for determining subset(s) of resources may be more complex than the latter or signaling approach, the former approach is associated with less signaling overhead than the latter approach. Moreover, in contrast to the former approach, the latter approach may be simpler to execute since the UE 802 may apply it regardless of whether the UE 802 has information regarding the downlink resource allocation(s) 708, 710. For example, the UE 802 may determine the subset(s) of resources from layer 1, 2, or 3 signaling even when the UE 802 is not informed of, or without regard to being informed of, the overlapping downlink resource allocation(s). Similarly, in other examples, the UE 802 may apply either the former or latter approach depending on whether or not the UE is informed of the downlink resource allocation(s) 708, 710. For example, the UE may determine the subset(s) of resources using one or more deterministic functions in response to receiving information regarding the overlapping downlink resource allocation(s) via semi-static signaling from the base station 804 or via sidelink signaling from another UE, while the UE may in contrast determine the subset(s) of resources explicitly from layer 1, 2, or 3 signaling in response to not receiving information regarding the overlapping downlink resource allocation(s).

Next, at block 820, after determining respective uplink resource allocation(s) at block 806 from subset(s) of resources in first uplink resource allocation 702 such as second uplink resource allocation 704 and third uplink resource allocation 706, the UE 802 may obtain different uplink power control parameters associated with the respective uplink resource allocations. These power control parameters may be, for example, identical or similar parameters to those described with respect to Equation (1) for PUSCH transmissions or Equation (2) for PUCCH transmissions. For example, the obtained parameters for different resource allocations may include, but are not limited to, nominal power components 822 (such as P_{O_NOMINAL,PUSCH,f,c} (j) or P_{O_NOMINAL,PUCCH} in the aforementioned Equation(s)), initial power components 824 (such as P_{O_UE_PUCCH} (qᵤ) or P_{O_UE_PUCCH} (qᵤ) in the aforementioned Equation(s)), RB quantities 826 (such as M_{RB,b,f,c}^{PUSCH}(I) or M_{RB,b,f,c}^{PUCCH}(i) in the aforementioned Equation(s)), parameters 828 associated with RACH or SRS (such as α_{b,f,c} (j) in the aforementioned Equation(s)), parameters 830 associated with MCS (such as Δ_{TF,b,f,c} (i) in the aforementioned Equation(s)) or PUCCH formats (such a Δ_{F_PUCCH} (F) in the aforementioned Equation(s)), power control adjustment states 832 (such as f_{p,f,c} (I, 1) or g_{b,f,c}(I,1) in the aforementioned Equation(s)), configured maximum output powers 834 (such as P_{CMAX,f,c} (i) in the aforementioned Equation(s)), a default configured maximum output power 836 and an offset 838 (described in more detail below), an UL resource allocation percentage 840 and associated configured parameter 842 (also described in more detail below), or a combination of multiple of the foregoing parameters.

To achieve different power control schemes, one or more of these parameters may have a different value for a subset of first uplink resource allocation 702, such as second uplink resource allocation 704 or third uplink resource allocation 706, than for first uplink resource allocation 702 itself. For instance, the UE 802 may obtain one nominal or initial power component 822, 824 associated with first uplink resource allocation 702 and a different nominal or initial power component 822, 824 associated with second uplink resource allocation 704, the UE 802 may obtain one RB quantity 826 associated with first uplink resource allocation 702 and a different RB quantity 826 associated with second uplink resource allocation 704, the UE 802 may obtain one parameter 828, 830 associated with first uplink resource allocation 702 and a different parameter 828, 830 associated with second uplink resource allocation 704, the UE 802 may obtain one power control adjustment state 832 associated with first uplink resource allocation 702 and a different power control adjustment state 832 associated with second uplink resource allocation 704, the UE 802 may obtain one configured maximum output power 834 associated with first uplink resource allocation 702 and a different configured maximum output powers 834 associated with second uplink resource allocation 704, or the like. The UE 802 may similarly obtain different values of such parameters for third uplink resource allocation 706, or for other uplink resource allocations determined at block 806, if such allocations are present. The UE 802 may obtain these parameter(s), for example, via an indication of such parameters from the base station 804 in an RRC configuration 844, MAC-CE 846, or DCI 848 (or in RRC configuration 814, MAC-CE 816, or DCI 818), in response to performing a calculation using a formula or function related to uplink power control, or in some other manner.

In a first aspect, at block 820, the UE 802 may obtain and apply different uplink power control parameters or equations for uplink transmissions in different resource allocations. More particularly, the UE 802 may obtain, in response to an indication or configuration from the base station 804, a performed calculation, or in some other manner, different sets of PUSCH or PUCCH power control parameters which are respectively associated with power control formulas or equations for different uplink resource allocations. For instance, the UE 802 may obtain one set of PUSCH power control parameters or PUCCH power control parameters associated with one power control equation, represented below by Equation (3) for PUSCH or Equation (4) for PUCCH, for the UE 802 to apply in configured or granted uplink resource allocations such as first uplink resource allocation 702, while the UE 802 may obtain another set of PUSCH power control parameters or PUCCH power control parameters associated with another power control equation, represented below by Equation (5) for PUSCH or Equation (6) for PUCCH, for the UE to apply in second uplink resource allocation 704, third uplink resource allocation 706, or another determined uplink resource allocation subset at block 806:

$${P}_{PUSCH , b , f , c}^{1} ( i , j , {q}_{d} , l ) = min \{ \begin{matrix}{P}_{CMAX , f , c} ( i ) , \\ {P}_{{O}_{PUSCH} , b , f , c}^{1} ( j ) + 10 {log}_{10} ( {2}^{μ} \cdot {M}_{RB , b , f , c}^{{1}^{PUSCH}} ( i ) ) + {α}_{b , f , c}^{1} ( j ) \cdot {PL}_{b , f , c} ( {q}_{d} ) + {Δ}_{TF , b , f , c}^{1} ( i ) + {f}_{b , f , c}^{1} ( i , l )\end{matrix} \} [ dBM ] \qquad ( 3 )$$

$${P}_{PUCCH , b , f , c}^{1} ( i , {q}_{u} , {q}_{d} , l ) = min \{ \begin{matrix}{P}_{CMAX , f , c} ( i ) , \\ {P}_{{O}_{PUCCH} , b , f , c}^{1} ( {q}_{u} ) + 10 {log}_{10} ( {2}^{μ} \cdot {M}_{RB , b , f , c}^{{1}^{PUCCH}} ( i ) ) + {PL}_{b , f , c} ( {q}_{d} ) + {Δ}_{{F}_{PUCCH}}^{1} ( F ) + {Δ}_{TF , b , f , c}^{1} ( i ) + {g}_{b , f , c}^{1} ( i , l )\end{matrix} \} [ dBM ] \qquad ( 4 )$$

$${P}_{PUSCH , b , f , c}^{2} ( i , j , {q}_{d} , l ) = min \{ \begin{matrix}{P}_{CMAX , f , c} ( i ) , \\ {P}_{{O}_{PUSCH} , b , f , c}^{2} ( j ) + 10 {log}_{10} ( {2}^{μ} \cdot {M}_{RB , b , f , c}^{{2}^{PUSCH}} ( i ) ) + {α}_{b , f , c}^{2} ( j ) \cdot {PL}_{b , f , c} ( {q}_{d} ) + {Δ}_{TF , b , f , c}^{2} ( i ) + {f}_{b , f , c}^{2} ( i , l )\end{matrix} \} [ dBM ] \qquad ( 5 )$$

$${P}_{PUCCH , b , f , c}^{2} ( i , {q}_{u} , {q}_{d} , l ) = min \{ \begin{matrix}{P}_{CMAX , f , c} ( i ) , \\ {P}_{{O}_{PUCCH} , b , f , c}^{2} ( {q}_{u} ) + 10 {log}_{10} ( {2}^{μ} \cdot {M}_{RB , b , f , c}^{{2}^{PUCCH}} ( i ) ) + {PL}_{b , f , c} ( {q}_{d} ) + {Δ}_{{F}_{PUCCH}}^{2} ( F ) + {Δ}_{TF , b , f , c}^{2} ( i ) + {g}_{b , f , c}^{2} ( i , l )\end{matrix} \} [ dBM ] \qquad ( 6 )$$

Here, the PUSCH and PUCCH parameters of Equations (3) and (4) respectively are the same as the parameters of Equations (1) and (2) but include values specifically associated with first uplink resource allocation 702 as designated by superscript ‘1’, while the PUSCH and PUCCH parameters of Equations (5) and (6) respectively are likewise the same as the parameters of Equations (1) and (2) but include values specifically associated with second uplink resource allocation 704 or third uplink resource allocation 706 as designated by superscript ‘2’. Thus, the aforementioned sets of PUSCH or PUCCH power control parameters may include similar parameters as in Equations (1) or (2) including nominal power components 822, initial power components 824, RB quantities 826, parameters 828 associated with RACH or SRS, parameters 830 associated with MCS or PUCCH formats, or power control adjustment states 832.

However, one or more of these parameters associated with first uplink resource allocation 702 in Equations (3) or (4) include a different value than a corresponding parameter for the same channel which is associated with second uplink resource allocation 704, third uplink resource allocation 706, or another determined uplink resource allocation subset at block 806 in Equations (5) or (6). For instance, the nominal power component 822 or initial power component 824 of the term P¹_{O}_{_{PUSCH}}_{,b,f,c}(j) in Equation (3) may have a different value than the nominal power component 822 or the initial power component 824 of the corresponding term P²_{O}_{_{PUSCH}}_{,b,f,c}(j) in Equation (5), the RB quantity 826 M¹_{RB,b,f,c}^{PUSCH} (i) in Equation (3) may have a different value than the corresponding RB quantity 826 M²_{RB,b,f,c}^{PUSCH} in Equation (5), one or more of parameters 828, 830 in Equation (3) may have different values than corresponding parameter(s) 828, 830 in Equation (5), or power control adjustment state 832 in Equation (3) may have a different value than the corresponding power control adjustment state 832 in Equation (5). Similarly, the nominal power component 822 or initial power component 824 of the term P²_{O}_{_{PUCCH}}_{,b,f,c} in Equation (4) may have a different value than the nominal power component 822 or the initial power component 824 of the corresponding term P²_{O}_{_{PUCCH}}_{,b,f,c} in Equation (6), the RB quantity 826 M¹_{RB,b,f,c}^{PUCCH}(i) in Equation (4) may have a different value than the corresponding RB quantity 826 M²_{RB,b,f,c}^{PUCCH} in Equation (6), one or more of parameters 828, 830 in Equation (4) may have different values than corresponding parameter(s) 828, 830 in Equation (6), or the power control adjustment state 832 in Equation (4) may have a different value than the corresponding power control adjustment state 832 in Equation (6).

As a result of the different valued parameter(s), the UE 802 may obtain different transmission powers for the different uplink resource allocations. For instance, the calculated values of P¹_{PUSCH,b,f,c}(i, j, q_{d}, 1) or P¹_{PUCCH,b,f,c}(i, qᵤ, q_{d}, I) specifically associated with first uplink resource allocation 702 as designated by superscript ‘1’ may be different than the calculated values of P²_{PUSCH,b,f,c}(i, j, q_{d}, 1) or P²_{PUCCH,b,f,c}(i, qᵤ, q_{d}, 1) specifically associated with second uplink resource allocation 704 or third uplink resource allocation 706 as designated by superscript ‘2’. Moreover, the different-valued power control parameter(s) for different resource allocations may be semi-statically indicated or dynamically indicated parameters in a single configuration or message such as RRC configuration 844, MAC-CE 846, or DCI 848, or in multiple respective configurations or messages such as multiple RRC configurations 844, MAC-CEs 846, or DCIs 848.

In a second aspect, at block 820, the UE 802 may obtain and apply different configured maximum output powers for uplink transmissions in respective uplink resource allocations. More particularly, the UE 802 may obtain, in response to an indication or configuration from the base station 804, a performed calculation, or in some other manner, multiple configured maximum output powers 834 in one example, or multiple offsets 838 to a default configured maximum output power 836 in another example, which are respectively associated with different uplink resource allocations. For instance, the configured maximum output powers 834 or offsets 838 may include different values for first uplink resource allocation 702 than for second uplink resource allocation 704 or third uplink resource allocation 706.

In one example of this second aspect, the UE 802 may obtain multiple configured maximum output powers 834 which are respectively associated with the different uplink resource allocations. The configured maximum output powers 834 may respectively correspond to the P_{CMAX,f,c} (I) parameter represented in Equations (1) and (2) but include different values for respective uplink resource allocations. For example, the UE 802 may obtain one value P¹_{CMAX,f,c}(I) designated by superscript ‘1’ for first uplink resource allocation 702 and another value P²_{CMAX,f,c}(I) designated by superscript ‘2’ for second uplink resource allocation 704 or third uplink resource allocation 706. The UE 802 may obtain these different configured maximum output powers 834 for respective uplink resource allocations, for example, in an indication or configuration from the base station 804, such as in DCI 848 (a layer 1 configuration), MAC-CE 846 (a layer 2 configuration), or RRC configuration 844 (a layer 3 configuration). After obtaining the multiple configured maximum output powers 834, the UE 802 may control the configured maximum output power P_{CMAX,f,c} (I) of its PUSCH or PUCCH transmissions in the different resource allocations according to the respectively obtained values.

In another example of this second aspect at block 820, the UE 802 may obtain multiple offsets 838 to the default configured maximum output power 836 which are respectively associated with the different uplink resource allocations. More particularly, rather than obtaining multiple configured maximum output powers 834 or values for P_{CMAX,f,c} (I) as in the former example, here the UE 802 may receive a single, default configured maximum output power and one or multiple offsets 838 to this default power 836, where the offset values are different for respective uplink resource allocations. For instance, the UE 802 may obtain the P_{CMAX,f,c} (I) parameter represented in Equations (1) and (2) as the default power 836, and the UE 802 may further obtain as offsets 838 one or more offset values with respect to this default power 836 which are respectively associated with different uplink resource allocations. For example, the UE 802 may receive a first offset value which, when offset with respect to this default power 836, results in one configured maximum output power or P¹_{CMAX,f,c}(I) designated with superscript ‘1’ for first uplink resource allocation 702, and the UE 802 may receive a second offset value which, when offset with respect to this same default power 836, results in a different configured maximum output power or P²_{CMAX,f,c}(I) designated with superscript ‘2’ for second uplink resource allocation 704 or third uplink resource allocation 706. In an alternative example, an offset value associated with first uplink resource allocation 702, such as the first offset value in the previous example, may not be configured or otherwise not obtained by the UE, in which case the UE 802 may interpret this first offset value to be zero and the configured maximum output power P_{CMAX,f,c} (I) for first uplink resource allocation 702 to thus be the default power 836. In either example, the UE may obtain the default power 836, the one or more offsets 838, or both the default power 836 and one or more offset values, semi-statically or dynamically from the base station 804 in at least one indication or configuration such as in DCI 848 (a layer 1 configuration), MAC-CE 846 (a layer 2 configuration), or RRC configuration 844 (a layer 3 configuration). Moreover, while the aforementioned example refers to these power control parameters as being semi-statically indicated or dynamically indicated parameters in a single configuration or message such as RRC configuration 844, MAC-CE 846, or DCI 848, these parameters may alternatively be indicated in multiple respective configurations or messages such as multiple RRC configurations 844, MAC-CEs 846, or DCIs 848.

In a third aspect, at block 820, the UE 802 may obtain and apply one or more uplink resource allocation percentages 840 and associated configured parameters 842 for power control of uplink transmissions in different uplink resource allocations. More particularly, the UE 802 may obtain, in response to an indication or configuration from the base station 804, a performed calculation, or in some other manner, multiple uplink power control parameters including an UL resource allocation percentage x and an associated configured parameter β. These parameters, when combined, may result in a term which value is different for respective uplink resource allocations. For example, the UE 802 may obtain the term βx for second uplink resource allocation 704 or third uplink resource allocation 706, while the UE 802 may obtain the different-valued term β(1-x) for first uplink resource allocation 702. After obtaining the combined term(s), the UE may apply these term(s) to a PUSCH or PUCCH power control equation, such as those represented by Equation (1) or (2), to result in different uplink transmission powers for respective uplink resource allocations. Thus, the combined term βx or β(1-x) may serve as a transmission power offset in PUSCH or PUCCH power control for a respective uplink resource allocation, where β and x are individual components of the transmission power offset.

More particularly, the UE 802 may obtain the uplink resource allocation percentage 840 (x) based on the number of RBs in the first uplink resource allocation 702 and the number of RBs in the second uplink resource allocation 704 or the third uplink resource allocation 706. The percentage x may be obtained at the UE 802 via a calculation, derivation, or in some other manner. For instance, if the first uplink resource allocation 702 includes 100 RBs and the UE 802 determines at block 806 that the second uplink resource allocation 704 includes 20 RBs, the UE 802 may calculate a value of 0.2 for x or 20% as the uplink resource allocation percentage 840 associated with second uplink resource allocation 704. Similarly, the UE 802 may obtain a value of 0.8 for (1-x) or 80% as the uplink resource allocation percentage 840 associated with first uplink resource allocation 702. Thus, the term βx or β(1-x) may be a function of the first uplink resource allocation 702, as well as the second uplink resource allocation 704, the third uplink resource allocation 706, or other defined region overlapping with downlink resource allocation 708, 710.

Moreover, the UE 802 may obtain the associated configured parameter 842 (β) in an indication or configuration from the base station 804, such as in DCI 848 (a layer 1 configuration), MAC-CE 846 (a layer 2 configuration), or RRC configuration 844 (a layer 3 configuration). This parameter β may be associated with a transmission power, such as a dB value, and the UL resource allocation percentage x or (1-x) may serve as a weight on this transmission power. For example, β may be semi-statically or dynamically configured with a dB value such as 10 dB, and this dB value may be reduced proportionally by x or (1-x) to correspond with the size of the associated uplink resource allocation. Thus, in the aforementioned example where the first uplink resource allocation 702 includes 100 RB, the second uplink resource allocation 704 includes 20 RBs (and thus x=20% and (1-x)=80%), and β=10 dB, the UE may calculate a value of 2 dB as a power offset for second uplink resource allocation 704 and a value of 8 dB as a power offset for first uplink resource allocation 702. In this way, the base station may give the associated configured parameter β more or less weight in the overall PUSCH or PUCCH power control scheme in different uplink resources based on the size or percentage x associated with the corresponding uplink resource allocation.

After obtaining the combined term βx or β(1-x), the UE 802 may apply these term(s) to a PUSCH or PUCCH power control equation, such as those represented by Equation (1) or (2), to result in different uplink transmission powers for respective uplink resource allocations. For example, the UE 802 may derive Equation (7) for PUSCH or Equation (8) for PUCCH below using the UL resource allocation percentage x and the associated configured parameter β for respective transmissions in second uplink resource allocation 704 or third uplink resource allocation 706. Similarly, the UE may also derive Equation (9) for PUSCH or Equation (10) for PUCCH below using the UL resource allocation percentage (1-x) and the associated configured parameter β for respective transmissions in the remainder of first uplink resource allocation 702.

$${P}_{PUSCH , b , f , c} ( i , j , {q}_{d} , l ) = min \{ \begin{matrix}{P}_{CMAX , f , c} ( i ) , \\ {P}_{{O}_{PUSCH} , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) + β x\end{matrix} \} [ dBM ] \qquad ( 7 )$$

$${P}_{PUCCH , b , f , c} ( i , {q}_{u} , {q}_{d} , l ) = min \{ \begin{matrix}{P}_{CMAX , f , c} ( i ) , \\ {P}_{{O}_{PUCCH} , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + {Δ}_{{F}_{PUCCH}} ( F ) + {Δ}_{TF , b , f , c} ( i ) + {g}_{b , f , c} ( i , l ) + β x\end{matrix} \} [ dBM ] \qquad ( 8 )$$

$${P}_{PUSCH , b , f , c} ( i , j , {q}_{d} , l ) = min \{ \begin{matrix}{P}_{CMAX , f , c} ( i ) , \\ {P}_{{O}_{PUSCH} , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) + β ( 1 - x )\end{matrix} \} [ dBM ] \qquad ( 9 )$$

$${P}_{PUCCH , b , f , c} ( i , {q}_{u} , {q}_{d} , l ) = min \{ \begin{matrix}{P}_{CMAX , f , c} ( i ) , \\ {P}_{{O}_{PUCCH} , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + {Δ}_{{F}_{PUCCH}} ( F ) + {Δ}_{TF , b , f , c} ( i ) + {g}_{b , f , c} ( i , l ) + β ( 1 - x )\end{matrix} \} [ dBM ] \qquad ( 10 )$$

Here, in the aforementioned equations, the parameters (other than βx) of Equations (7) and (8) are the same as the parameters of Equations (1) and (2), and the parameters (other than β(1-x)) of Equations (9) and (10) are likewise the same as the parameters of Equations (1) and (2). Thus, the UE 802 may obtain and apply different uplink transmission powers for respective uplink resource allocations in response to a configured or indicated value of β and different values of x which the UE 802 may derive from the corresponding uplink resource allocations. Additionally, while in this example the parameter β is configured uniformly for different uplink resource allocations, in other examples β may be configured separately for respective uplink resource allocations. For instance, different βs may be respectively applied for first uplink resource allocation 702 and second uplink resource allocation 704 or third uplink resource allocation 706. In such case, the multiple, associated configured parameters β may be semi-statically indicated or dynamically indicated parameters in a single configuration or message such as RRC configuration 844, MAC-CE 846, or DCI 848, or in multiple respective configurations or messages such as multiple RRC configurations 844, MAC-CEs 846, or DCIs 848.

In a fourth aspect, at block 820, the UE 802 may again obtain and apply uplink power control parameters associated with different uplink resource allocations as in the previous three aspects, but here according to a combination of two or more of the aforementioned aspects. For instance, the UE may obtain one or more of: nominal power components 822, initial power components 824, RB quantities 826, parameters 828 associated with RACH or SRS, parameters 830 associated with MCS or PUCCH formats, or power control adjustment states 832 associated with respective uplink resource allocations 702, 704, 706 in accordance with the first aspect, in combination with one or more parameters for different uplink resource allocations 702, 704, 706 associated with the second or third aspects. For instance, on top of the aforementioned parameters associated with the first aspect, the UE 802 may additionally obtain configured maximum output powers 834 for different uplink resource allocations 702, 704, 706, or default powers 836 and offsets 838 for different uplink resource allocations 702, 704, 706, in accordance with the second aspect. Alternatively or additionally, the UE may additionally obtain uplink resource allocation percentages 840 for different uplink resource allocations 702, 704, 706 and associated configured parameters 842 in accordance with the third aspect. The UE 802 may then apply this combination of obtained uplink power control parameters in a PUSCH or PUCCH power control equation to obtain different uplink transmission powers for respective uplink resource allocations 702, 704, 706. For example, the UE 802 may calculate a PUSCH or PUCCH transmission power using a similar function to that of Equation (1) or (2), which combines different parameters of corresponding functions of Equations (3-10) or a subset of these Equations across multiple of the aforementioned aspects. In this way, an aggressor UE may further achieve a balance between improved uplink coverage and minimized inter-UE interference or NLIC complexity at a victim UE using a combination of multiple, aforementioned power control schemes.

Lastly, at block 850, after obtaining the uplink power control parameters at block 820 according to the first, second, third, or fourth aspects, the UE 802 may send to the base station 804 multiple uplink transmissions. More particularly, the UE 802 may transmit uplink data in the uplink resource allocations determined at block 806 respectively using different transmission powers associated with the uplink power control parameters obtained at block 820. As a result of the different-valued parameters obtained at block 820, the UE 802 may transmit uplink data in second uplink resource allocation 704 or third uplink resource allocation 706 with a lesser transmission power than that which the UE 802 applies to first uplink resource allocation 702.

For example, the UE 802 may initially send a first uplink transmission 852 including PUSCH or PUCCH data in first uplink resource allocation 702 using a first transmission power calculated from parameters in one or more of the aforementioned PUSCH or PUCCH power control equations (3-10), such as those designated with superscript ‘1’ for first uplink resource allocation 702. Simultaneously or subsequently, the UE 802 may send a second uplink transmission 854 including PUSCH data or PUCCH data in second uplink resource allocation 704 using a second transmission power calculated from parameters in different one(s) of the aforementioned PUSCH or PUCCH power control equations (3-10), such as those designated with superscript ‘2’ for second uplink resource allocation 704. The UE 802 may also simultaneously or subsequently send a third uplink transmission 856 including PUSCH data or PUCCH data in third uplink resource allocation 706 using a third transmission power calculated from parameters in additional or same one(s) of the aforementioned PUSCH or PUCCH power control equations (3-10), such as those designated with superscript ‘2’ or a different superscript for third uplink resource allocation 706. As a result, since different values for uplink power control parameters are configured, indicated, determined, or otherwise associated with these uplink resource allocations 702, 704, 706, the UE 802 may obtain different transmission powers for respective uplink resource allocations. In this way, a balance between improved uplink coverage at the aggressor UE and minimized inter-UE interference or NLIC complexity at a victim UE may be achieved.

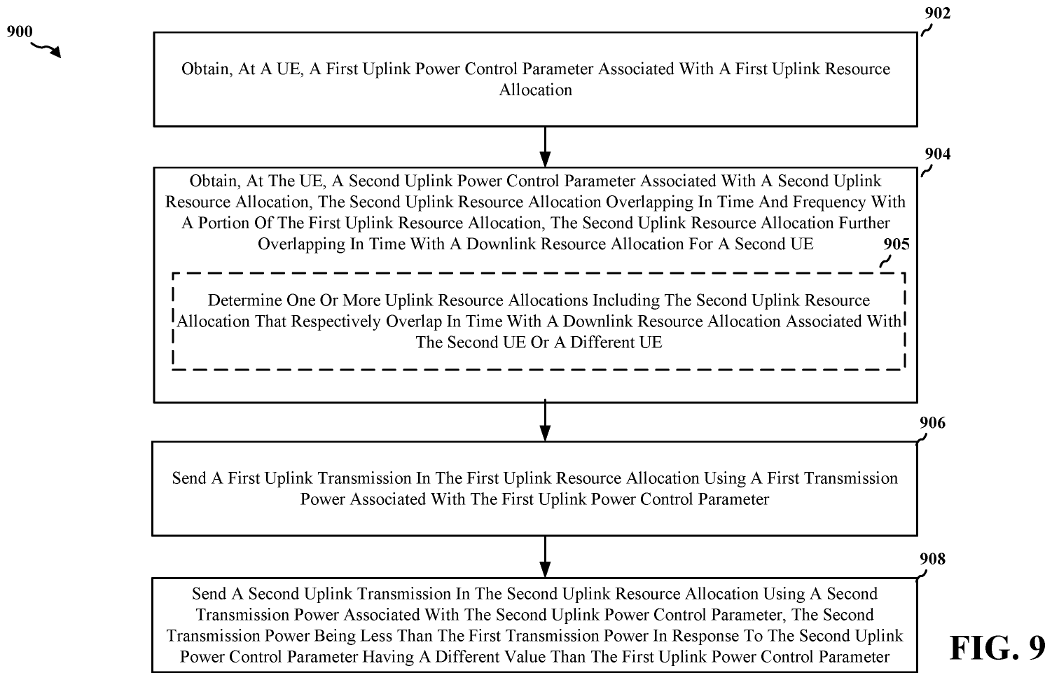

FIG. 9 is a flowchart 900 of an example method or process for wireless communication performable at a first UE which applies different transmission power schemes in respective uplink resource allocations to mitigate inter-UE interference impacting a second UE or to simplify NLIC at the second UE. The method may be performed by a UE, such as the UE 104, 350, 802, second UE 406, the apparatus 1002, or its components as described herein.

In block 902, the first UE obtains a first uplink power control parameter associated with a first uplink resource allocation. For example, block 902 may be performed by power control parameter component 1042. For instance, referring to the Figures, UE 802 or power control parameter component 1042 may obtain, at block 820, one nominal power component 822, initial power component 824, or a function of the nominal power component 822 and initial power component 824 for PUSCH or PUCCH power control in first uplink resource allocation 702, one RB quantity 826 for PUSCH or PUCCH power control in first uplink resource allocation 702, one parameter 828 for PUSCH or PUCCH power control in first uplink resource allocation 702, one parameter 830 for PUSCH or PUCCH power control in first uplink resource allocation 702, one power control adjustment state 832 for PUSCH or PUCCH power control in first uplink resource allocation 702, one configured maximum output power 834 for PUSCH or PUCCH power control in first uplink resource allocation 702, one offset 838 to default configured maximum output power 836 for PUSCH or PUCCH power control in first uplink resource allocation 702, one UL resource allocation percentage 840 and associated configured parameter 842 for PUSCH or PUCCH power control in first uplink resource allocation 702, or a combination of multiple of the foregoing parameters. For example, these uplink power control parameters may be parameters designated by superscript ‘1’ in one or more of the functions given by Equations (3-10). The UE 802 may obtain these parameter(s), for example, via receiving an indication of such parameters from the base station 804 in an RRC configuration 844, MAC-CE 846, or DCI 848 (or in RRC configuration 814, MAC-CE 816, or DCI 818), in response to performing a calculation using a formula or function related to uplink power control, or in some other manner. Moreover, first uplink resource allocation 702 includes resources which base station 402 configures or schedules to second UE 406 for sending uplink data such as PUSCH data or PUCCH data. For instance, first uplink resource allocation 702 may be indicated in an uplink grant, a configured grant configuration, or the like.

In block 904, the first UE obtains a second uplink power control parameter associated with a second uplink resource allocation. For example, block 904 may also be performed by power control parameter component 1042. The second uplink power control parameter has a different value than the first uplink power control parameter obtained at block 902. For instance, referring to the Figures, UE 802 or power control parameter component 1042 may obtain, at block 820, a nominal power component 822, an initial power component 824, or a function of the nominal power component 822 and initial power component 824 for PUSCH or PUCCH power control in second uplink resource allocation 704, an RB quantity 826 for PUSCH or PUCCH power control in second uplink resource allocation 704, one parameter 828 for PUSCH or PUCCH power control in second uplink resource allocation 704, one parameter 830 for PUSCH or PUCCH power control in second uplink resource allocation 704, one power control adjustment state 832 for PUSCH or PUCCH power control in second uplink resource allocation 704, one configured maximum output power 834 for PUSCH or PUCCH power control in second uplink resource allocation 704, one offset 838 to default configured maximum output power 836 for PUSCH or PUCCH power control in second uplink resource allocation 704, one UL resource allocation percentage 840 and associated configured parameter 842 for PUSCH or PUCCH power control in second uplink resource allocation 704, or a combination of multiple of the foregoing parameters. One or more of these parameters for uplink power control in second uplink resource allocation 704 may have different values than corresponding parameters obtained for uplink power control in first uplink resource allocation 702. For example, one or more of these uplink power control parameters for second uplink resource allocation 704 may be parameters designated by superscript ‘2’ and having different values than corresponding parameters designated by superscript ‘1’ in one or more of the functions given by Equations (3-10). The UE 802 may similarly obtain these parameter(s), for example, via receiving an indication of such parameters from the base station 804 in an RRC configuration 844, MAC-CE 846, or DCI 848 (or in RRC configuration 814, MAC-CE 816, or DCI 818), in response to performing a calculation using a formula or function related to uplink power control, or in some other manner.

The first UE may similarly obtain additional uplink power control parameters associated respectively with additional uplink resource allocations. For example, the first UE may obtain a third uplink power control parameter respectively associated with a third uplink resource allocation. The third uplink power control parameter has a different value than the first uplink power control parameter obtained at block 902. For instance, referring to the Figures, UE 802 or power control parameter component 1042 may obtain, at block 820, a nominal power component 822, an initial power component 824, or a function of the nominal power component 822 and initial power component 824 for PUSCH or PUCCH power control in third uplink resource allocation 706, an RB quantity 826 for PUSCH or PUCCH power control in third uplink resource allocation 706, one parameter 828 for PUSCH or PUCCH power control in third uplink resource allocation 706, one parameter 830 for PUSCH or PUCCH power control in third uplink resource allocation 706, one power control adjustment state 832 for PUSCH or PUCCH power control third uplink resource allocation 706, one configured maximum output power 834 for PUSCH or PUCCH power control in third uplink resource allocation 706, one offset 838 to default configured maximum output power 836 for PUSCH or PUCCH power control in third uplink resource allocation 706, one UL resource allocation percentage 840 and associated configured parameter 842 for PUSCH or PUCCH power control in third uplink resource allocation 706, or a combination of multiple of the foregoing parameters. One or more of these parameters for uplink power control in third uplink resource allocation 706 may have different values than corresponding parameters obtained for uplink power control in first uplink resource allocation 702. For example, one or more of these uplink power control parameters for third uplink resource allocation 706 may be parameters designated by superscript ‘2’ and having different values than corresponding parameters designated by superscript ‘1’ in one or more of the functions given by Equations (3-10). The UE 802 may similarly obtain these parameter(s), for example, via receiving an indication of such parameters from the base station 804 in an RRC configuration 844, MAC-CE 846, or DCI 848 (or in RRC configuration 814, MAC-CE 816, or DCI 818), in response to performing a calculation using a formula or function related to uplink power control, or in some other manner.

The second uplink resource allocation overlaps in time and frequency with a portion of the first uplink resource allocation, and further overlaps in time with a downlink resource allocation for a second UE. Likewise, the third uplink resource allocation, if present, overlaps in time and frequency with another portion of the first uplink resource allocation, and further overlaps in time with another downlink resource allocation for the second UE or a different UE. For instance, referring to the Figures, second uplink resource allocation 704 may be a base station configured or UE determined subset of first uplink resource allocation 702, and thus includes resources which overlap in time and frequency with a portion of first uplink resource allocation 702 such as illustrated in FIG. 7. Similarly, third uplink resource allocation 706 may be another base station configured or UE determined subset of first uplink resource allocation 702, and thus likewise includes resources which overlap in time and frequency with another portion of first uplink resource allocation 702 such as illustrated in FIG. 7. The resources of second uplink resource allocation 704 and third uplink resource allocation 706 may also be prone to inter-UE interference 408. For example, second uplink resource allocation 704 and third uplink resource allocation 706 may respectively include resources of first uplink resource allocation 702 which overlap in time with downlink resource allocation 708 or downlink resource allocation 710 to another UE such as first UE 404, and which frequencies may be associated with non-linear signal effects such as non-linearities 602. Such non-linearities 602 may be challenging for this other UE to cancel using NLIC 502 due to these uplink resources' relative proximity to downlink resource allocation 708 or downlink resource allocation 710.

In block 905, the first UE may determine one or more uplink resource allocations including the second uplink resource allocation that respectively overlap in time with the downlink resource allocation or another downlink resource allocation associated with the second UE or a different UE. Here, a respective uplink resource allocation of the one or more uplink resource allocations may be determined based on: an amount of frequency separation between the respective uplink resource allocation and the downlink resource allocation or the another downlink resource allocation, a subcarrier spacing associated with the respective uplink resource allocation, the downlink resource allocation, or the another downlink resource allocation, and a power class associated with the UE or associated with the second UE or the different UE. For instance, referring to the Figures and at block 806, UE 802 may determine the subset(s) of resources of first uplink resource allocation 702 in which to apply different power control scheme(s) based on one or more factors or parameters of a configured or pre-configured function such as a formula or equation. These factor(s) may include but are not limited to, for example, a frequency separation 808 or number of RBs between an uplink resource and an overlapping downlink resource in the time domain to a different UE such as first UE 404, a subcarrier spacing 810 associated with the uplink resource or the time overlapping downlink resource, and a power class 812 or category of the UE 802 or the different UE. The UE 802 may apply this function, or multiple functions using these same or different factor(s), to determine the subset(s) of resources of first uplink resource allocation 702 that are likely to cause inter-UE interference 408. For instance, the UE 802 may apply these factor(s) to determine the time-frequency locations of second uplink resource allocation 704 and third uplink resource allocation 706 and the number of such uplink resource allocations. In other examples, more or less uplink resource allocation(s) overlapping in time with downlink resource allocations may be determined based on same or different factor(s). Accordingly, the UE 802 may consider the proximity of uplink resources to downlink resource allocations 708, 710 as indicated by frequency separation 808 and subcarrier spacing 810, as well as the transmission power capabilities of the aggressor UE or victim UE as indicated by power class 812, to ascertain the quantity and location of time-frequency resources in uplink resource allocation(s) 704, 706. For example, if the UE 802 determines that certain resources of first uplink resource allocation 702 have a certain amount of frequency separation at a given SCS to a time-overlapping, downlink resource allocation of another UE such as downlink resource allocation 708, 710, and that these resources are associated with a higher power aggressor UE or overlap in time with downlink resources associated with a lower power victim UE having less sophisticated NLIC capability, the UE 802 may identify these resources as being prone to inter-UE interference. As a result, the UE may designate these resources for different power control in second uplink resource allocation 704 or third uplink resource allocation 706.

In some examples, the second uplink resource allocation may be indicated in DCI, a MAC-CE, or a RRC configuration. For instance, referring to the Figures and at block 806, UE 802 may determine the subset(s) of resources of first uplink resource allocation 702 in which to apply different power control scheme(s) based on layer 1, layer 2, or layer 3 signaling. For instance, the base station 804 may transmit an indication in an RRC configuration 814, MAC-CE 816, or DCI 818 of the subset(s) of resources of first uplink resource allocation 702 in which the UE is to apply a different power control scheme than that applied to first uplink resource allocation 702. Accordingly, the UE 802 may ascertain the quantity and location of time-frequency resources in uplink resource allocation(s) 704, 706 from the received indication. For example, one or more RRC configurations 814, MAC-CEs 816, DCIs 818, or a combination of these configurations, may indicate to UE 802 the quantities and location of the time-frequency resources for second uplink resource allocation 704 and third uplink resource allocation 706.

In block 906, the first UE sends a first uplink transmission in the first uplink resource allocation using a first transmission power associated with the first uplink power control parameter. For example, block 906 may be performed by transmission power component 1042. For instance, referring to the Figures, UE 802 or power control parameter component 1042 may send to base station 804, at block 850, first uplink transmission 852 in first uplink resource allocation 702. For example, the UE 802 or power control parameter component 1042 may transmit uplink data in PUSCH or PUCCH in first uplink resource allocation 702 using a first transmission power (such as P¹_{PUSCH,b,f,c}(i, j, q_{d}, 1) or P¹_{PUCCH, b,f,c}(i, qᵤ, q_{d}, 1)) calculated using one or more of the uplink power control parameters obtained at block 820 and designated with superscript ‘1’ in one or more of the functions given by Equations (3-10).

In block 908, the first UE sends a second uplink transmission in the second uplink resource allocation using a second transmission power associated with the second uplink power control parameter. For example, block 908 may also be performed by transmission power component 1042. For instance, referring to the Figures, UE 802 or power control parameter component 1042 may send to base station 804, at block 850, second uplink transmission 854 in second uplink resource allocation 704 simultaneously with, subsequently to, or prior to, first uplink transmission 852 in first uplink resource allocation 702. For example, the UE 802 or power control parameter component 1042 may transmit uplink data in PUSCH or PUCCH in second uplink resource allocation 704 using a second transmission power (such as P²_{PUSCH,b,f,c}(i, j, q_{d}, 1) or P²_{PUCCH, b,f,c}(i, qᵤ, q_{d}, 1)) calculated using one or more of the uplink power control parameters obtained at block 820 and designated with superscript ‘2’ in one or more of the functions given by Equations (3-10).

Similarly, if additional uplink resource allocations are present, the first UE may send additional uplink transmissions respectively in the additional uplink resource allocations using an additional transmission power respectively associated with the additional uplink power control parameters. For instance, if the first UE obtains a third uplink power control parameter respectively associated with a third uplink resource allocation, the first UE may send a third uplink transmission in the third uplink resource allocation using a third transmission power associated with the third uplink power control parameter. For instance, referring to the Figures, UE 802 or power control parameter component 1042 may send to base station 804, at block 850, third uplink transmission 856 in third uplink resource allocation 706 simultaneously with, subsequently to, or prior to, first uplink transmission 852 in first uplink resource allocation 702. For example, the UE 802 or power control parameter component 1042 may transmit uplink data in PUSCH or PUCCH in third uplink resource allocation 706 using a third transmission power (such as P²_{PUSCH,b,f,c}(i, j, q_{d}, 1) or P²_{PUCCH,b,f,c}(i, qᵤ, q_{d}, 1)) calculated using one or more of the uplink power control parameters obtained at block 820 and designated with superscript ‘2’ in one or more of the functions given by Equations (3-10).

Moreover, the second transmission power is less than the first transmission power in response to the second uplink power control parameter having a different value than the first uplink power control parameter. Similarly, the third transmission power, if present, may be less than the first transmission power in response to the third uplink power control parameter having a different value than the first uplink power control parameter. For instance, referring to the Figures, one or more of the parameter(s) obtained at block 820 and used to calculate the second transmission power for second uplink transmission 854 or the third transmission power for third uplink transmission 856 has different value(s) than the corresponding parameter(s) used to calculate the first transmission power for first uplink transmission 852. More specifically, these different value(s) are configured or determined such that the calculated second transmission power or third transmission power is less than the calculated first transmission power. For example, an uplink power control parameter designated with superscript ‘2’ may be obtained at block 820 with a lesser value than the same uplink power control parameter designated with superscript ‘1’ in one or more of the functions given by Equations (3-10). As a result, the UE 802 may obtain a lesser transmission power for second uplink resource allocation 704 or for third uplink resource allocation 706 than for first uplink resource allocation 702.

In some examples, the first uplink power control parameter is a first function of a first nominal power component and a first initial power component, and the second uplink power control parameter is a second function of a second nominal power component and a second initial power component, where the second nominal power component is different than the first nominal power component or the second initial power component is different than the first initial power component. In some examples, the first uplink power control parameter is a first quantity of resource blocks in the first uplink resource allocation, and the second uplink power control parameter is a second quantity of resource blocks in the second uplink resource allocation which is different than the first quantity of resource blocks. In some examples, the first uplink power control parameter and the second uplink power control parameter are different valued parameters respectively associated with random access or a sounding reference signal. In some examples, the first uplink power control parameter and the second uplink power control parameter are different valued parameters respectively associated with a MCS or a PUCCH format. In some examples, the first uplink power control parameter is a first power control adjustment state, and the second uplink power control parameter is a second power control adjustment state different than the first power control adjustment state. For instance, referring to the Figures and in accordance with various examples of the first aspect at block 820, the UE 802 may obtain one set of power control parameters associated with Equation (3) for PUSCH or Equation (4) for PUCCH for the UE 802 to apply in first uplink resource allocation 702, while the UE 802 may obtain another set of power control parameters associated with Equation (5) for PUSCH or Equation (6) for PUCCH for the UE to apply in second uplink resource allocation 704. The aforementioned sets of power control parameters may include nominal power components 822, initial power components 824, RB quantities 826, parameters 828 associated with RACH or SRS, parameters 830 associated with MCS or PUCCH formats, power control adjustment states 832, or a combination of multiple of the foregoing parameters, where one or more of these parameters associated with first uplink resource allocation 702 include a different value than a corresponding parameter for the same channel which is associated with second uplink resource allocation 704. For instance, the nominal power component 822 or initial power component 824 of the term P¹_{O}_{_{PUSCH}}_{,b,f,c}(j) in Equation (3) (which term is a function of those components) may have a different value than the nominal power component 822 or the initial power component 824 of the corresponding term P²_{O}_{_{PUSCH}}_{,b,f,c}(j) in Equation (5) (which term is likewise a function of those corresponding components), the RB quantity 826 M¹_{RB,b,f,c}^{PUSCH} (i) in Equation (3) may have a different value than the corresponding RB quantity 826 M²_{RB,b,f,c}^{PUSCH} in Equation (5), one or more of parameters 828, 830 in Equation (3) may have different values than corresponding parameter(s) 828, 830 in Equation (5), or power control adjustment state 832 in Equation (3) may have a different value than the corresponding power control adjustment state 832 in Equation (5).

In some examples, the first uplink power control parameter is a first configured maximum output power, and the second uplink power control parameter is a second configured maximum output power different than the first configured maximum output power. In some examples, the first configured maximum output power and the second configured maximum output power are obtained from respective DCIs, MAC-CEs, or RRC configurations. For instance, referring to the Figures and in accordance with one example of the second aspect at block 820, the UE 802 may obtain multiple configured maximum output powers 834 which are respectively associated with the different uplink resource allocations. For example, the UE 802 may obtain one value P¹_{CMAX,f,c} (1) designated by superscript ‘1’ for first uplink resource allocation 702 and another, different value P²_{CMAX,f,c} (1) designated by superscript ‘2’ for second uplink resource allocation 704 or third uplink resource allocation 706. The UE 802 may obtain these different configured maximum output powers 834 for respective uplink resource allocations, for example, in at least one indication or configuration from the base station 804, such as in DCI 848 (a layer 1 configuration), MAC-CE 846 (a layer 2 configuration), or RRC configuration 844 (a layer 3 configuration).

In some examples, the first configured maximum output power is a function of a default configured maximum output power and a first offset, and the second configured maximum output power is a function of the default configured maximum output power and a second offset different than the first offset. In some examples, the first offset, the second offset, and the default configured maximum output power are indicated in respective DCIs, MAC-CEs, or RRC configurations. For instance, referring to the Figures and in accordance with another example of the second aspect at block 820, the UE 802 may obtain multiple offsets 838 to the default configured maximum output power 836 which are respectively associated with the different uplink resource allocations. More particularly, rather than obtaining multiple configured maximum output powers 834 or values for P_{CMAX,f,c} (1) as in the former example, here the UE 802 may receive a single, default configured maximum output power and one or multiple offsets 838 to this default power 836, where the offset values are different for respective uplink resource allocations. For instance, the UE 802 may obtain the P_{CMAX,f,c} (1) parameter represented in Equations (1) and (2) as the default power 836, and the UE 802 may further obtain as offsets 838 one or more offset values with respect to this default power 836 which are respectively associated with different uplink resource allocations. For example, the UE 802 may receive a first offset value which, when offset with respect to this default power 836, results in one configured maximum output power or P¹_{CMAX,f,c} (I) designated with superscript ‘1’ for first uplink resource allocation 702, and the UE 802 may receive a second offset value which, when offset with respect to this same default power 836, results in a different configured maximum output power or P²_{CMAX,f,c}(1) designated with superscript ‘2’ for second uplink resource allocation 704 or third uplink resource allocation 706. Thus, P¹_{CMAX,f,c}(1) may be a function of the default configured maximum output power 836 and one offset 838, while P²_{CMAX,f,c}(1) may be a function of the default configured maximum output power 836 and a different-valued offset 838. The UE may obtain the default power 836, the one or more offsets 838, or both the default power 836 and one or more offset values, semi-statically or dynamically from the base station 804 in at least one indication or configuration such as in DCI 848 (a layer 1 configuration), MAC-CE 846 (a layer 2 configuration), or RRC configuration 844 (a layer 3 configuration).

In some examples, the first uplink power control parameter is a function of a configured parameter and a percentage of the first uplink resource allocation that does not overlap in time with the downlink resource allocation, the second uplink power control parameter is a function of the configured parameter and a percentage of the first uplink resource allocation that overlaps in time with the downlink resource allocation, and the configured parameter is indicated in DCI, a MAC-CE, or a RRC configuration. For instance, referring to the Figures and in accordance with the third aspect at block 820, the UE 802 may obtain the parameter or term βx for second uplink resource allocation 704 or third uplink resource allocation 706, and the different-valued term β(1−x) for first uplink resource allocation 702. This term β(1−x) (the first uplink power control parameter in this example) or βx (the second uplink power control parameter in this example) is a function of one or more uplink resource allocation percentages 840 (x or 1−x) and associated configured parameters 842(β). The uplink resource allocation percentage 840(x) in the term βx (the second uplink power control parameter in this example) may be based on the number of RBs in the first uplink resource allocation 702 and the number of RBs in the second uplink resource allocation 704 or the third uplink resource allocation 706 which overlap in time with downlink resource allocation 708 or downlink resource allocation 710. For instance, if the first uplink resource allocation 702 includes 100 RBs and the UE 802 determines at block 806 that the second uplink resource allocation 704 overlapping with downlink resource allocation 708 includes 20 RBs, the UE 802 may calculate a value of 0.2 for x or 20% as the uplink resource allocation percentage 840 associated with second uplink resource allocation 704. The uplink resource allocation percentage 840(1-x) in the term β(1-x) (the first uplink power control parameter in this example) may be based on the number of RBs in the first uplink resource allocation 702 and the number of RBs in the second uplink resource allocation 704 or the third uplink resource allocation 706 which do not overlap in time with downlink resource allocation 708 or downlink resource allocation 710. For instance, in the aforementioned example where x is 20%, the UE 802 may determine that the resources of first uplink resource allocation 702 not overlapping with downlink resource allocation 708 includes 80 RBs, and thus the UE 802 may calculate a value of 0.8 for (1-x) or 80% as the uplink resource allocation percentage 840 associated with first uplink resource allocation 702. Moreover, the UE 802 may obtain the associated configured parameter 842 (β) in an indication or configuration from the base station 804, such as in DCI 848 (a layer 1 configuration), MAC-CE 846 (a layer 2 configuration), or RRC configuration 844 (a layer 3 configuration). This parameter β may be associated with a transmission power, such as a dB value, and the UL resource allocation percentage x or (1-x) may serve as a weight on this transmission power.

In some examples, the first uplink power control parameter and the second uplink power control parameter include at least one of: different nominal power components, different initial power components, different quantities of resource blocks, different valued parameters respectively associated with random access or a sounding reference signal, different valued parameters respectively associated with a MCS or a PUCCH format, different power control adjustment states, different configured maximum output powers, different offsets with respect to a default configured maximum output power, or different percentages of the first uplink resource allocation. For instance, referring to the Figures and in accordance with the fourth aspect at block 820, the UE 802 may obtain one or more of: nominal power components 822, initial power components 824, RB quantities 826, parameters 828 associated with RACH or SRS, parameters 830 associated with MCS or PUCCH formats, or power control adjustment states 832 associated with respective uplink resource allocations 702, 704, 706 in accordance with the first aspect, in combination with one or more parameters for different uplink resource allocations 702, 704, 706 associated with the second or third aspects. For instance, on top of the aforementioned parameters associated with the first aspect, the UE 802 may additionally obtain configured maximum output powers 834 for different uplink resource allocations 702, 704, 706, or default powers 836 and offsets 838 for different uplink resource allocations 702, 704, 706, in accordance with the second aspect. Alternatively or additionally, the UE may additionally obtain uplink resource allocation percentages 840 for different uplink resource allocations 702, 704, 706 and associated configured parameters 842 in accordance with the third aspect.

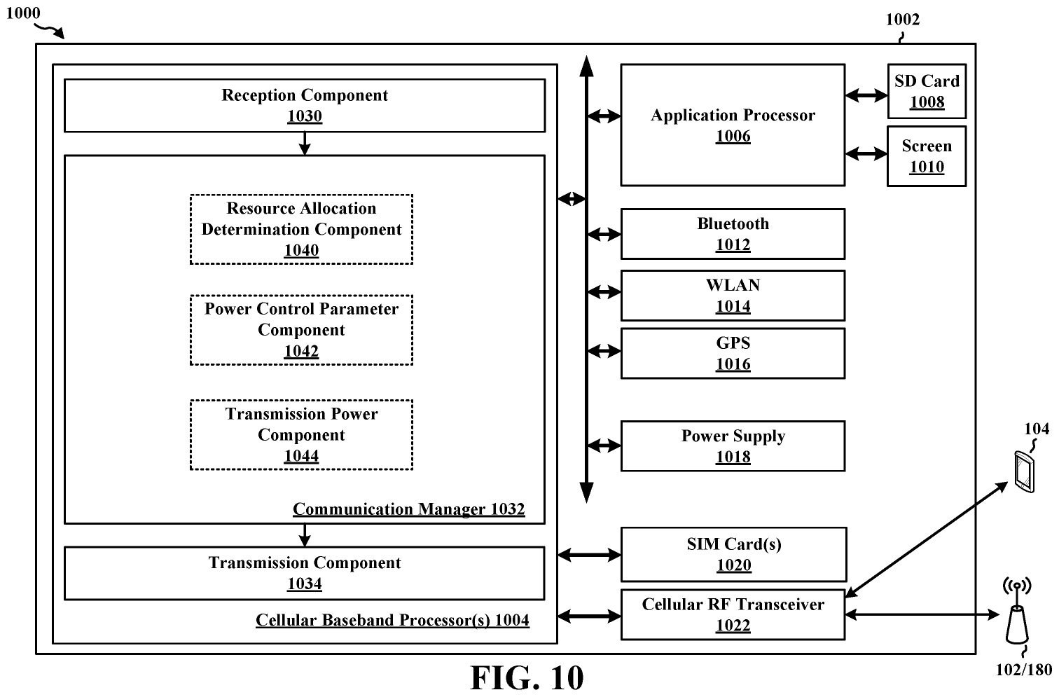

FIG. 10 is a diagram 1000 illustrating an example of a hardware implementation for an apparatus 1002 that applies different transmission power schemes in respective uplink resource allocations to mitigate inter-UE interference or to simplify NLIC according to some aspects of the present disclosure. The apparatus 1002 is a UE such as second UE 406 and includes one or more cellular baseband processors 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The one or more cellular baseband processors 1004 communicate through the cellular RF transceiver 1022 with the UE 104 and/or BS 102. The one or more cellular baseband processors 1004 may each include a computer-readable medium/one or more memories. The computer-readable medium/one or more memories may be non-transitory. The one or more cellular baseband processors 1004 are responsible for general processing, including the execution of software stored on the computer-readable medium/one or more memories individually or in combination. The software, when executed by the one or more cellular baseband processors 1004, causes the one or more cellular baseband processors 1004 to, individually or in combination, perform the various functions described supra. The computer-readable medium/one or more memories may also be used individually or in combination for storing data that is manipulated by the one or more cellular baseband processors 1004 when executing software. The one or more cellular baseband processors 1004 individually or in combination further include a reception component 1030, a communication manager 1032, and a transmission component 1034. The communication manager 1032 includes the one or more illustrated components. The components within the communication manager 1032 may be stored in the computer-readable medium/one or more memories and/or configured as hardware within the one or more cellular baseband processors 1004. The one or more cellular baseband processors 1004 may be components of the UE 104, 350, 802 or second UE 406 and may individually or in combination include the one or more memories 360 and/or at least one of the one or more TX processors 368, at least one of the one or more RX processors 356, and at least one of the one or more controllers/processors 359. In one configuration, the apparatus 1002 may be a modem chip and include just the one or more baseband processors 1004, and in another configuration, the apparatus 1002 may be the entire UE (e.g., see UE 350 of FIG. 3) and include the aforediscussed additional modules of the apparatus 1002.

The communication manager 1032 includes a resource allocation determination component 1040 that is configured to determine one or more uplink resource allocations including the second uplink resource allocation 704 that respectively overlap in time with the downlink resource allocation 708 or another downlink resource allocation (such as downlink resource allocation 710) associated with another UE (such as first UE 404), such as described in connection with block 905 of FIG. 9. As an example of this determination process, the resource allocation determination component 1040 may initially obtain, via reception component 1030, a configuration or grant indicating first uplink resource allocation 702 in which one power control scheme is to be applied. In such case, reception component 1030 may be configured to receive, demodulate and decode the configuration or grant and provide the demodulated and decoded configuration or grant indicating the first uplink resource allocation 702 to the resource allocation determination component 1040, where the reception, demodulation and decoding may be performed such as described in connection with FIG. 3. The resource allocation determination component 1040 may then identify subset(s) of resources of the first uplink resource allocation 702 which overlap in time with downlink resource allocation 708 or downlink resource allocation 710 of another UE to subsequently be categorized as second uplink resource allocation 704 or third uplink resource allocation 706. For example, the resource allocation determination component 1040 may identify a respective uplink resource allocation of the one or more uplink resource allocations such as second uplink resource allocation 704 based on: an amount of frequency separation between the respective uplink resource allocation and the downlink resource allocation or the another downlink resource allocation, a subcarrier spacing associated with the respective uplink resource allocation, the downlink resource allocation, or the another downlink resource allocation, and a power class associated with the apparatus (second UE 406) or associated with the other UE, also such as described in connection with block 905 of FIG. 9. As an example of this identification process within the overall determination process, the resource allocation determination component 1040 may ascertain that certain resources of first uplink resource allocation 702 have a certain amount of frequency separation at a given SCS to a time-overlapping, downlink resource allocation of another UE such as downlink resource allocation 708, 710, and that these resources are associated with a higher power aggressor UE or overlap in time with downlink resources associated with a lower power victim UE having less sophisticated NLIC capability. In such case, the resource allocation determination component 1040 may categorize these resources as being prone to inter-UE interference through designation of these resources for different power control in second uplink resource allocation 704 or third uplink resource allocation 706.

The communication manager 1032 further includes a power control parameter component 1042 that is configured to obtain a first uplink power control parameter associated with a first uplink resource allocation, and to obtain a second uplink power control parameter associated with a second uplink resource allocation, such as described in connection with blocks 902 and 904 of FIG. 9. As an example of this obtaining process, the power control parameter component 1042 may receive, via reception component 1030, an indication or configuration from the base station 804 including one or more of the uplink power control parameters described with respect to FIG. 9 for first uplink resource allocation 702 (such as one of the aforementioned parameters of Equations (3-10) designated with superscript ‘1’) and second uplink resource allocation 704 (such as one of the aforementioned parameters of Equations (3-10) designated with superscript ‘2’). In such case, reception component 1030 may be configured to receive, demodulate and decode the uplink power control parameters and provide the demodulated and decoded parameters to the power control parameter component 1042, where the reception, demodulation and decoding may be performed such as described in connection with FIG. 3. Alternatively or additionally, the power control parameter component 1042 may derive one or more of the uplink power control parameters described with respect to FIG. 9 in response to a performed calculation using one or more other components associated with an uplink power control function, such as using the nominal or initial power components associated with one or more of Equations (3-10). In either case, as previously described, the second uplink resource allocation 704 overlaps in time and frequency with a portion (a subset) of the first uplink resource allocation, and the second uplink resource allocation further overlaps in time with a downlink resource allocation for another UE such as downlink resource allocation 708.

The communication manager 1032 also includes a transmission power component 1044 configured to send a first uplink transmission in the first uplink resource allocation using a first transmission power associated with the first uplink power control parameter, and to send a second uplink transmission in the second uplink resource allocation using a second transmission power associated with the second uplink power control parameter, such as described in connection with blocks 906 and 908 of FIG. 9. As an example of this sending process, the transmission power component 1044 may derive different uplink transmission powers for respective uplink resource allocations 702, 704, 706 from one or more power control functions such as Equations (3-10) (depending on whether the transmission is for PUSCH or PUCCH) using at least one power control parameter for the first uplink resource allocation 702 having a different value than a corresponding parameter for the second uplink resource allocation 704 (such as those designated with superscript ‘1’ and ‘2’). The derived second transmission power may be less than the derived first transmission power as a result of the different valued parameters. After obtaining the different transmission powers, the transmission power component 1044 may transmit, via transmission component 1034, uplink data in the respective uplink resource allocations 702, 704, 706 using the different transmission powers for the respective uplink transmissions 852, 854, 856. The transmission component 1034 may be configured to encode, modulate, and transmit the uplink data in the respective uplink transmissions 852, 854, 856, where the coding, modulation, and transmission may likewise be performed such as described in connection with FIG. 3.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1002, and in particular the one or more cellular baseband processors 1004, includes means for obtaining a first uplink power control parameter associated with a first uplink resource allocation, where the means for obtaining is further configured to obtain a second uplink power control parameter associated with a second uplink resource allocation. In this configuration, the second uplink resource allocation overlaps in time and frequency with a portion of the first uplink resource allocation, and the second uplink resource allocation further overlaps in time with a downlink resource allocation for a UE. The apparatus 1002, and in particular the one or more cellular baseband processors 1004, further includes means for sending a first uplink transmission in the first uplink resource allocation using a first transmission power associated with the first uplink power control parameter, where the means for sending is further configured to send a second uplink transmission in the second uplink resource allocation using a second transmission power associated with the second uplink power control parameter. In this configuration, the second transmission power is less than the first transmission power in response to the second uplink power control parameter having a different value than the first uplink power control parameter.

In one configuration, the apparatus 1002, and in particular the one or more cellular baseband processors 1004, includes means for determining one or more uplink resource allocations including the second uplink resource allocation that respectively overlap in time with the downlink resource allocation or another downlink resource allocation associated with the UE or a different UE, where a respective uplink resource allocation of the one or more uplink resource allocations is determined based on: an amount of frequency separation between the respective uplink resource allocation and the downlink resource allocation or the another downlink resource allocation, a subcarrier spacing associated with the respective uplink resource allocation, the downlink resource allocation, or the another downlink resource allocation, and a power class associated with the apparatus or associated with the UE or the different UE.

The aforementioned means may be one or more of the aforementioned components of the apparatus 1002 configured to perform the functions recited by the aforementioned means. For example, in one configuration, the means for obtaining may be the power control parameter component 1042 or the reception component 1030, the means for sending may be the transmission power component 1044 or the transmission component 1034, and the means for determining may be the resource allocation determination component 1040. Moreover, as described supra, the apparatus 1002 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X. Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored therecon instructions for performing actions X. Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X. Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X. Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X. Y, and Z. Alternatively, three processors may access one of three different memories each storing one of instructions for performing X. Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. A method for wireless communication performable at a first UE, comprising: obtaining a first uplink power control parameter associated with a first uplink resource allocation; obtaining a second uplink power control parameter associated with a second uplink resource allocation, the second uplink resource allocation overlapping in time and frequency with a portion of the first uplink resource allocation, the second uplink resource allocation further overlapping in time with a downlink resource allocation for a second UE; sending a first uplink transmission in the first uplink resource allocation using a first transmission power associated with the first uplink power control parameter; and sending a second uplink transmission in the second uplink resource allocation using a second transmission power associated with the second uplink power control parameter, the second transmission power being less than the first transmission power in response to the second uplink power control parameter having a different value than the first uplink power control parameter.

Clause 2. The method of clause 1, further comprising: obtaining a third uplink power control parameter respectively associated with a third uplink resource allocation, the third uplink resource allocation overlapping in time and frequency with another portion of the first uplink resource allocation, and the third uplink resource allocation further overlapping in time with another downlink resource allocation for the second UE or a different UE; and sending a third uplink transmission in the third uplink resource allocation using a third transmission power associated with the third uplink power control parameter, the third transmission power being less than the first transmission power in response to the third uplink power control parameter having a different value than the first uplink power control parameter.

Clause 3. The method of clause 1 or clause 2, wherein the first uplink power control parameter is a first function of a first nominal power component and a first initial power component, and the second uplink power control parameter is a second function of a second nominal power component and a second initial power component, the second nominal power component being different than the first nominal power component or the second initial power component being different than the first initial power component.

Clause 4. The method of any of clauses 1 to 3, wherein the first uplink power control parameter is a first quantity of resource blocks in the first uplink resource allocation, and the second uplink power control parameter is a second quantity of resource blocks in the second uplink resource allocation which is different than the first quantity of resource blocks.

Clause 5. The method of any of clauses 1 to 4, wherein the first uplink power control parameter and the second uplink power control parameter are different valued parameters respectively associated with random access or a sounding reference signal.

Clause 6. The method of any of clauses 1 to 5, wherein the first uplink power control parameter and the second uplink power control parameter are different valued parameters respectively associated with a MCS or a PUCCH format.

Clause 7. The method of any of clauses 1 to 6, wherein the first uplink power control parameter is a first power control adjustment state, and the second uplink power control parameter is a second power control adjustment state different than the first power control adjustment state.

Clause 8. The method of any of clauses 1 to 7, wherein the first uplink power control parameter is a first configured maximum output power, and the second uplink power control parameter is a second configured maximum output power different than the first configured maximum output power.

Clause 9. The method of clause 8, wherein the first configured maximum output power and the second configured maximum output power are obtained from respective DCIs, MAC-CEs, or RRC configurations.

Clause 10. The method of clause 8 or clause 9, wherein the first configured maximum output power is a function of a default configured maximum output power and a first offset, and the second configured maximum output power is a function of the default configured maximum output power and a second offset different than the first offset.

Clause 11. The method of clause 10, wherein the first offset, the second offset, and the default configured maximum output power are indicated in respective DCIs, MAC-CEs, or RRC configurations.

Clause 12. The method of any of clauses 1 to 11, wherein the first uplink power control parameter is a function of a configured parameter and a percentage of the first uplink resource allocation that does not overlap in time with the downlink resource allocation, the second uplink power control parameter is a function of the configured parameter and a percentage of the first uplink resource allocation that overlaps in time with the downlink resource allocation, and the configured parameter is indicated in DCI, a MAC-CE, or a RRC configuration.

Clause 13. The method of any of clauses 1 to 12, wherein the first uplink power control parameter and the second uplink power control parameter include at least one of: different nominal power components, different initial power components, different quantities of resource blocks, different valued parameters respectively associated with random access or a sounding reference signal, different valued parameters respectively associated with a MCS or a PUCCH format, different power control adjustment states, different configured maximum output powers, different offsets with respect to a default configured maximum output power, or different percentages of the first uplink resource allocation.

Clause 14. The method of any of clauses 1 to 13, wherein the second uplink resource allocation is indicated in DCI, a MAC-CE, or a RRC configuration.

Clause 15. The method of any of clauses 1 to 14, further comprising: determining one or more uplink resource allocations including the second uplink resource allocation that respectively overlap in time with the downlink resource allocation or another downlink resource allocation associated with the second UE or a different UE, wherein a respective uplink resource allocation of the one or more uplink resource allocations is determined based on: an amount of frequency separation between the respective uplink resource allocation and the downlink resource allocation or the another downlink resource allocation, a subcarrier spacing associated with the respective uplink resource allocation, the downlink resource allocation, or the another downlink resource allocation, and a power class associated with the UE or associated with the second UE or the different UE.

Clause 16. An apparatus for wireless communication, comprising: one or more memories; and one or more processors each communicatively coupled with at least one of the one or more memories, the one or more processors, individually or in any combination, operable to cause the apparatus to: obtain a first uplink power control parameter associated with a first uplink resource allocation; obtain a second uplink power control parameter associated with a second uplink resource allocation, the second uplink resource allocation overlapping in time and frequency with a portion of the first uplink resource allocation, the second uplink resource allocation further overlapping in time with a downlink resource allocation for a UE; send a first uplink transmission in the first uplink resource allocation using a first transmission power associated with the first uplink power control parameter; and send a second uplink transmission in the second uplink resource allocation using a second transmission power associated with the second uplink power control parameter, the second transmission power being less than the first transmission power in response to the second uplink power control parameter having a different value than the first uplink power control parameter.

Clause 17. The apparatus of clause 16, wherein the first uplink power control parameter is a first function of a first nominal power component and a first initial power component, and the second uplink power control parameter is a second function of a second nominal power component and a second initial power component, the second nominal power component being different than the first nominal power component or the second initial power component being different than the first initial power component.

Clause 18. The apparatus of clause 16 or clause 17, wherein the first uplink power control parameter is a first quantity of resource blocks in the first uplink resource allocation, and the second uplink power control parameter is a second quantity of resource blocks in the second uplink resource allocation which is different than the first quantity of resource blocks.

Clause 19. The apparatus of any of clauses 16 to 18, wherein the first uplink power control parameter and the second uplink power control parameter are different valued parameters respectively associated with random access or a sounding reference signal.

Clause 20. The apparatus of any of clauses 16 to 19, wherein the first uplink power control parameter and the second uplink power control parameter are different valued parameters respectively associated with a MCS or a PUCCH format.

Clause 21. The apparatus of any of clauses 16 to 20, wherein the first uplink power control parameter is a first power control adjustment state, and the second uplink power control parameter is a second power control adjustment state different than the first power control adjustment state.

Clause 22. The apparatus of any of clauses 16 to 21, wherein the first uplink power control parameter is a first configured maximum output power, and the second uplink power control parameter is a second configured maximum output power different than the first configured maximum output power.

Clause 23. The apparatus of clause 22, wherein the first configured maximum output power and the second configured maximum output power are obtained from respective DCIs, MAC-CEs, or RRC configurations.

Clause 24. The apparatus of clause 22 or clause 23, wherein the first configured maximum output power is a function of a default configured maximum output power and a first offset, and the second configured maximum output power is a function of the default configured maximum output power and a second offset different than the first offset.

Clause 25. The apparatus of clause 24, wherein the first offset, the second offset, and the default configured maximum output power are indicated in respective DCIs, MAC-CEs, or RRC configurations.

Clause 26. The apparatus of any of clauses 16 to 25, wherein the first uplink power control parameter is a function of a configured parameter and a percentage of the first uplink resource allocation that does not overlap in time with the downlink resource allocation, the second uplink power control parameter is a function of the configured parameter and a percentage of the first uplink resource allocation that overlaps in time with the downlink resource allocation, and the configured parameter is indicated in DCI, a MAC-CE, or a RRC configuration.

Clause 27. The apparatus of any of clauses 16 to 26, wherein the one or more processors, individually or in combination, are further operable to cause the apparatus to: determine one or more uplink resource allocations including the second uplink resource allocation that respectively overlap in time with the downlink resource allocation or another downlink resource allocation associated with the UE or a different UE, wherein a respective uplink resource allocation of the one or more uplink resource allocations is determined based on: an amount of frequency separation between the respective uplink resource allocation and the downlink resource allocation or the another downlink resource allocation, a subcarrier spacing associated with the respective uplink resource allocation, the downlink resource allocation, or the another downlink resource allocation, and a power class associated with the apparatus or associated with the UE or the different UE.

Clause 28. An apparatus for wireless communication, comprising: means for obtaining a first uplink power control parameter associated with a first uplink resource allocation, the means for obtaining being further configured to obtain a second uplink power control parameter associated with a second uplink resource allocation, the second uplink resource allocation overlapping in time and frequency with a portion of the first uplink resource allocation, the second uplink resource allocation further overlapping in time with a downlink resource allocation for a UE; and means for sending a first uplink transmission in the first uplink resource allocation using a first transmission power associated with the first uplink power control parameter, the means for sending being further configured to send a second uplink transmission in the second uplink resource allocation using a second transmission power associated with the second uplink power control parameter, the second transmission power being less than the first transmission power in response to the second uplink power control parameter having a different value than the first uplink power control parameter.

Clause 29. The apparatus of clause 28, further comprising: means for determining one or more uplink resource allocations including the second uplink resource allocation that respectively overlap in time with the downlink resource allocation or another downlink resource allocation associated with the UE or a different UE, wherein a respective uplink resource allocation of the one or more uplink resource allocations is determined based on: an amount of frequency separation between the respective uplink resource allocation and the downlink resource allocation or the another downlink resource allocation, a subcarrier spacing associated with the respective uplink resource allocation, the downlink resource allocation, or the another downlink resource allocation, and a power class associated with the apparatus or associated with the UE or the different UE.

Clause 30. A non-transitory, computer-readable medium comprising computer executable code, the code when executed by one or more processors causes the one or more processors to, individually or in combination: obtain a first uplink power control parameter associated with a first uplink resource allocation; obtain a second uplink power control parameter associated with a second uplink resource allocation, the second uplink resource allocation overlapping in time and frequency with a portion of the first uplink resource allocation, the second uplink resource allocation further overlapping in time with a downlink resource allocation for a UE; send a first uplink transmission in the first uplink resource allocation using a first transmission power associated with the first uplink power control parameter; and send a second uplink transmission in the second uplink resource allocation using a second transmission power associated with the second uplink power control parameter, the second transmission power being less than the first transmission power in response to the second uplink power control parameter having a different value than the first uplink power control parameter.

What is claimed is:

1. A method for wireless communication performable at a first user equipment (UE), comprising:
obtaining a first uplink power control parameter associated with a first uplink resource allocation;
obtaining a second uplink power control parameter associated with a second uplink resource allocation, the second uplink resource allocation overlapping in time and frequency with a portion of the first uplink resource allocation, the second uplink resource allocation further overlapping in time with a downlink resource allocation for a second UE;
sending a first uplink transmission in the first uplink resource allocation using a first transmission power associated with the first uplink power control parameter; and
sending a second uplink transmission in the second uplink resource allocation using a second transmission power associated with the second uplink power control parameter, the second transmission power being less than the first transmission power in response to the second uplink power control parameter having a different value than the first uplink power control parameter.

2. The method of claim 1, further comprising:
obtaining a third uplink power control parameter respectively associated with a third uplink resource allocation, the third uplink resource allocation overlapping in time and frequency with another portion of the first uplink resource allocation, and the third uplink resource allocation further overlapping in time with another downlink resource allocation for the second UE or a different UE; and
sending a third uplink transmission in the third uplink resource allocation using a third transmission power associated with the third uplink power control parameter, the third transmission power being less than the first transmission power in response to the third uplink power control parameter having a different value than the first uplink power control parameter.

3. The method of claim 1, wherein the first uplink power control parameter is a first function of a first nominal power component and a first initial power component, and the second uplink power control parameter is a second function of a second nominal power component and a second initial power component, the second nominal power component being different than the first nominal power component or the second initial power component being different than the first initial power component.

4. The method of claim 1, wherein the first uplink power control parameter is a first quantity of resource blocks in the first uplink resource allocation, and the second uplink power control parameter is a second quantity of resource blocks in the second uplink resource allocation which is different than the first quantity of resource blocks.

5. The method of claim 1, wherein the first uplink power control parameter and the second uplink power control parameter are different valued parameters respectively associated with random access or a sounding reference signal.

6. The method of claim 1, wherein the first uplink power control parameter and the second uplink power control parameter are different valued parameters respectively associated with a modulation and coding scheme (MCS) or a physical uplink control channel (PUCCH) format.

7. The method of claim 1, wherein the first uplink power control parameter is a first power control adjustment state, and the second uplink power control parameter is a second power control adjustment state different than the first power control adjustment state.

8. The method of claim 1, wherein the first uplink power control parameter is a first configured maximum output power, and the second uplink power control parameter is a second configured maximum output power different than the first configured maximum output power.

9. The method of claim 8, wherein the first configured maximum output power and the second configured maximum output power are obtained from respective downlink control information (DCIs), medium access control (MAC) control elements (MAC-CEs), or radio resource control (RRC) configurations.

10. The method of claim 8, wherein the first configured maximum output power is a function of a default configured maximum output power and a first offset, and the second configured maximum output power is a function of the default configured maximum output power and a second offset different than the first offset.

11. The method of claim 10, wherein the first offset, the second offset, and the default configured maximum output power are indicated in respective downlink control information (DCIs), medium access control (MAC) control elements (MAC-CEs), or radio resource control (RRC) configurations.

12. The method of claim 1, wherein the first uplink power control parameter is a function of a configured parameter and a percentage of the first uplink resource allocation that does not overlap in time with the downlink resource allocation, the second uplink power control parameter is a function of the configured parameter and a percentage of the first uplink resource allocation that overlaps in time with the downlink resource allocation, and the configured parameter is indicated in downlink control information (DCI), a medium access control (MAC) control element (MAC-CE), or a radio resource control (RRC) configuration.

13. The method of claim 1, wherein the first uplink power control parameter and the second uplink power control parameter include at least one of:
different nominal power components,
different initial power components,
different quantities of resource blocks,
different valued parameters respectively associated with random access or a sounding reference signal,
different valued parameters respectively associated with a modulation and coding scheme (MCS) or a physical uplink control channel (PUCCH) format,
different power control adjustment states,
different configured maximum output powers,
different offsets with respect to a default configured maximum output power, or
different percentages of the first uplink resource allocation.

14. The method of claim 1, wherein the second uplink resource allocation is indicated in downlink control information (DCI), a medium access control (MAC) control element (MAC-CE), or a radio resource control (RRC) configuration.

15. The method of claim 1, further comprising:
determining one or more uplink resource allocations including the second uplink resource allocation that respectively overlap in time with the downlink resource allocation or another downlink resource allocation associated with the second UE or a different UE, wherein a respective uplink resource allocation of the one or more uplink resource allocations is determined based on:
an amount of frequency separation between the respective uplink resource allocation and the downlink resource allocation or the another downlink resource allocation,
a subcarrier spacing associated with the respective uplink resource allocation, the downlink resource allocation, or the another downlink resource allocation, and
a power class associated with the UE or associated with the second UE or the different UE.

16. An apparatus for wireless communication, comprising:
one or more memories; and
one or more processors each communicatively coupled with at least one of the one or more memories, the one or more processors, individually or in any combination, operable to cause the apparatus to:
obtain a first uplink power control parameter associated with a first uplink resource allocation;
obtain a second uplink power control parameter associated with a second uplink resource allocation, the second uplink resource allocation overlapping in time and frequency with a portion of the first uplink resource allocation, the second uplink resource allocation further overlapping in time with a downlink resource allocation for a user equipment (UE);
send a first uplink transmission in the first uplink resource allocation using a first transmission power associated with the first uplink power control parameter; and
send a second uplink transmission in the second uplink resource allocation using a second transmission power associated with the second uplink power control parameter, the second transmission power being less than the first transmission power in response to the second uplink power control parameter having a different value than the first uplink power control parameter.

17. The apparatus of claim 16, wherein the first uplink power control parameter is a first function of a first nominal power component and a first initial power component, and the second uplink power control parameter is a second function of a second nominal power component and a second initial power component, the second nominal power component being different than the first nominal power component or the second initial power component being different than the first initial power component.

18. The apparatus of claim 16, wherein the first uplink power control parameter is a first quantity of resource blocks in the first uplink resource allocation, and the second uplink power control parameter is a second quantity of resource blocks in the second uplink resource allocation which is different than the first quantity of resource blocks.

19. The apparatus of claim 16, wherein the first uplink power control parameter and the second uplink power control parameter are different valued parameters respectively associated with random access or a sounding reference signal.

20. The apparatus of claim 16, wherein the first uplink power control parameter and the second uplink power control parameter are different valued parameters respectively associated with a modulation and coding scheme (MCS) or a physical uplink control channel (PUCCH) format.

21. The apparatus of claim 16, wherein the first uplink power control parameter is a first power control adjustment state, and the second uplink power control parameter is a second power control adjustment state different than the first power control adjustment state.

22. The apparatus of claim 16, wherein the first uplink power control parameter is a first configured maximum output power, and the second uplink power control parameter is a second configured maximum output power different than the first configured maximum output power.

23. The apparatus of claim 22, wherein the first configured maximum output power and the second configured maximum output power are obtained from respective downlink control information (DCIs), medium access control (MAC) control elements (MAC-CEs), or radio resource control (RRC) configurations.

24. The apparatus of claim 22, wherein the first configured maximum output power is a function of a default configured maximum output power and a first offset, and the second configured maximum output power is a function of the default configured maximum output power and a second offset different than the first offset.

25. The apparatus of claim 24, wherein the first offset, the second offset, and the default configured maximum output power are indicated in respective downlink control information (DCIs), medium access control (MAC) control elements (MAC-CEs), or radio resource control (RRC) configurations.

26. The apparatus of claim 16, wherein the first uplink power control parameter is a function of a configured parameter and a percentage of the first uplink resource allocation that does not overlap in time with the downlink resource allocation, the second uplink power control parameter is a function of the configured parameter and a percentage of the first uplink resource allocation that overlaps in time with the downlink resource allocation, and the configured parameter is indicated in downlink control information (DCI), a medium access control (MAC) control element (MAC-CE), or a radio resource control (RRC) configuration.

27. The apparatus of claim 16, wherein the one or more processors, individually or in combination, are further operable to cause the apparatus to:
determine one or more uplink resource allocations including the second uplink resource allocation that respectively overlap in time with the downlink resource allocation or another downlink resource allocation associated with the UE or a different UE, wherein a respective uplink resource allocation of the one or more uplink resource allocations is determined based on:
an amount of frequency separation between the respective uplink resource allocation and the downlink resource allocation or the another downlink resource allocation,
a subcarrier spacing associated with the respective uplink resource allocation, the downlink resource allocation, or the another downlink resource allocation, and
a power class associated with the apparatus or associated with the UE or the different UE.

28. An apparatus for wireless communication, comprising:
means for obtaining a first uplink power control parameter associated with a first uplink resource allocation,
the means for obtaining being further configured to obtain a second uplink power control parameter associated with a second uplink resource allocation, the second uplink resource allocation overlapping in time and frequency with a portion of the first uplink resource allocation, the second uplink resource allocation further overlapping in time with a downlink resource allocation for a user equipment (UE); and
means for sending a first uplink transmission in the first uplink resource allocation using a first transmission power associated with the first uplink power control parameter,
the means for sending being further configured to send a second uplink transmission in the second uplink resource allocation using a second transmission power associated with the second uplink power control parameter, the second transmission power being less than the first transmission power in response to the second uplink power control parameter having a different value than the first uplink power control parameter.

29. The apparatus of claim 28, further comprising:
means for determining one or more uplink resource allocations including the second uplink resource allocation that respectively overlap in time with the downlink resource allocation or another downlink resource allocation associated with the UE or a different UE, wherein a respective uplink resource allocation of the one or more uplink resource allocations is determined based on:
an amount of frequency separation between the respective uplink resource allocation and the downlink resource allocation or the another downlink resource allocation,
a subcarrier spacing associated with the respective uplink resource allocation, the downlink resource allocation, or the another downlink resource allocation, and
a power class associated with the apparatus or associated with the UE or the different UE.

30. A non-transitory, computer-readable medium comprising computer executable code, the code when executed by one or more processors causes the one or more processors to, individually or in combination:
obtain a first uplink power control parameter associated with a first uplink resource allocation;
obtain a second uplink power control parameter associated with a second uplink resource allocation, the second uplink resource allocation overlapping in time and frequency with a portion of the first uplink resource allocation, the second uplink resource allocation further overlapping in time with a downlink resource allocation for a user equipment (UE);
send a first uplink transmission in the first uplink resource allocation using a first transmission power associated with the first uplink power control parameter; and
send a second uplink transmission in the second uplink resource allocation using a second transmission power associated with the second uplink power control parameter, the second transmission power being less than the first transmission power in response to the second uplink power control parameter having a different value than the first uplink power control parameter.
